(19) United States
(12) Patent Application Publication
(10) Pub. No.: US 2020/0387818 A1
(43) Pub. Date: Dec. 10, 2020

(54) Asset Optimization Using Integrated Modeling, Optimization, and Artificial Intelligence

(71) Applicant: Aspen Technology, Inc., Bedford, MA (US)

(72) Inventors: Willie K. C. Chan, Framingham, MA (US); Benjamin Fischer, Winchester, MA (US); Dimitrios Varvarezos, Houston, TX (US); Ashok Rao, Sugar Land, TX (US); Hong Zhao, Sugar Land, TX (US)

(21) Appl. No.: 16/434,793

(22) Filed: Jun. 7, 2019

(51) Int. Cl. G06N 7/00; G06N 20/00; G06K 9/62; G06F 17/18

(52) U.S. Cl. CPC G06N 7/00; G06F 17/18; G06K 9/6267; G06N 20/00

(57) ABSTRACT

System and methods that provide a new paradigm for solving process system engineering (PSE) problems using embedded artificial intelligence (AI) techniques. The approach can facilitate process model building and deployment and benefits from emerging AI and machine learning (ML) technology. The systems and methods can define PSE problems with mathematical equations, first principles and domain knowledges, and physical and economical constraints. The systems and methods generate a dataset of recorded measurements for variables of the process, and reduce the dataset by cleansing bad quality data segments and measurements for uninformative process variables from the dataset. The dataset is then enriched by, for example, applying nonlinear transforms, engineering calculations, and statistical measurements. The systems and methods use for example, a simplified first principles model (FPM), AI/ML model, or both in a hybrid model format to build a model and solution, which is deployed online to perform asset optimization tasks in real-time plant operations.

### BACKGROUND

In the process industry, significant progress has been made over recent decades in process modeling, design, simulation, control, operation, and optimization. Chemical and petrochemical manufacturers have been benefited with those technology advances constantly and resulted in improved profit margin, production safety, and high product quality. These benefits mainly attribute to technology advances in process system engineering (PSE), such as process modeling, simulation, model-predictive-control, optimized scheduling, planning, and their broad implementations in plant design and operation. Recently, with the emergence of artificial intelligence (AI), particularly machine learning, the process industry has an opportunity to develop and implement asset optimization with embedded AI. On the other hand, this also raises many challenges to manufacturers and practitioners of asset optimization in the process industry.

In current process modeling and simulation practices, theoretical “full-scale” first-principles models are first choices for both offline simulation in plant design, analysis, debottlenecking, and online optimization. For example, offline analyses are critical for understanding, improving and optimizing a process. In most cases, these analyses add extra capacity with only a fraction of the cost of a new construction or expansion. However, those full-scale models may consist of up to thousands to millions of mathematical equations representing physical/chemical properties, mass, and energy balances in a process under consideration. Calibrating and running online such a full-scale model is very challenging in terms of cost and sustainability. This challenge heavily limits broad applicability in the process industry.

### SUMMARY

There are ways to facilitate modeling and simulation applications. For example, in an offline debottlenecking study, a process can be analyzed to improve production that does not meet demands of quantity or specifications. A hybrid model developed with AI and ML techniques from actual plant operating data can be significantly simplified and fast-to-run that allows a process engineer to run multiple scenarios to find improvements, such as adjusting operating conditions or replacing an entire piece of equipment. Additionally, AI embedded within the model can help engineers identify root-causes where operating parameters are not consistent with design specifications.

In the case of online optimization, a process optimizer can compare various conditions and calculate a set of optimal operation setpoints to, for example, maximize profits and/or minimize costs of the asset. These online calculations are performed based on a process model and an online solver to solve an optimization problem, which can be formulated with the steady-state process model containing economic information. Hybrid models built from historical data with the help of AI and ML can be deployed online for real-time optimization with less efforts. Embedded ML techniques can also ensure a performant and robust model, and the model can automatically self-sustain as new data becomes available. This removes the requirement of an engineer needing to re-tune or recalibrate a model offline.

One example embodiment is a method of building and deploying a model to optimize assets in an industrial process. The example method includes generating a dataset by loading a set of process variables of a subject industrial process. Each process variable includes measurements related to at least one component of the subject industrial process. The method further includes identifying and removing measurements that are invalid in quality for modeling the behavior of a subject industrial process (e.g., a specific period of large variations in product properties due to an undesirable event or failure), and enriching the dataset by deriving one or more feature variables and corresponding values based on the measurements of the set of process variables, adding to the dataset the values corresponding to the one or more derived feature variables. The method further includes identifying groups of highly correlated inputs by performing cross-correlation analysis on the dataset, and selecting features of the dataset using (a) a representative input from each identified group of highly correlated inputs, and (b) measurements of process variables not in the identified groups of highly correlated inputs. The method further includes building and training a process model based on the selected features of the dataset, and deploying the process model to optimize assets for real-time operations of the subject industrial process.

Another example embodiment is a computer system for building and deploying a model to optimize assets in an industrial process. The system includes a processor operatively coupled to a data storage system. The processor is configured to implement a data preparation module, a model development module, and an execution module. The data preparation module is configured to generate a dataset by loading a set of process variables of a subject industrial process. Each process variable includes measurements related to at least one component of the subject industrial process. The data preparation module is further configured to identify and remove measurements that are invalid in quality for modeling the subject industrial process (e.g., a specific period of large variations in product properties due to an undesirable event or failure), and to enrich the dataset by deriving one or more feature variables and corresponding values based on the measurements of the set of process variables, adding to the dataset the values corresponding to the one or more derived feature variables. The data preparation module is further configured to identify groups of highly correlated inputs by performing cross-correlation analysis on the dataset, and to select features of the dataset using (a) a representative input from each identified group of highly correlated inputs, and (b) measurements of process variables not in the identified groups of highly correlated inputs. The model development module is configured to build and train a process model based on the selected features of the dataset. The execution module is configured to deploy the process model to optimize assets for real-time operations of the subject industrial process. The system can further include a configuration module to automatically select a model type for the model development module to build and train the process model.

Another example embodiment is a non-transitory computer-readable data storage medium comprising instructions causing a computer to (i) generate a dataset by loading a set of process variables of a subject industrial process, where each process variable includes measurements related to at least one component of the subject industrial process, (ii) identify and remove measurements that are invalid in quality for modeling the subject industrial process, (iii) enrich the dataset by deriving one or more feature variables and corresponding values based on the measurements of the set of process variables, adding to the dataset the values corresponding to the one or more derived feature variables, (iv) identify groups of highly correlated inputs by performing cross-correlation analysis on the dataset, (v) select features of the dataset using (a) a representative input from each identified group of highly correlated inputs, and (b) measurements of process variables not in the identified groups of highly correlated inputs, (vi) build and train a process model based on the selected features of the dataset, and (vii) deploy the process model to optimize assets for real-time operations of the subject industrial process.

The measurements of each process variable can be loaded in a time-series format or structured data format from at least one of a plant historian data, plant asset database, plant management system, formatted spreadsheet, formatted text file, and formatted binary file.

The measurements that are invalid in quality can include any of: missing values, frozen signals, outlier values, values out of process in high and low limits, and extremely high noisy values.

Some embodiments include repairing the invalid in quality measurements by at least one of: filling in missing values using interpolation, applying none-phase-shift filters to de-trend drifting and filter noisy values, replacing values with model-produced values, up-sampling values with snapshots or calculated averages, and down-sampling values with interpolated values.

In some embodiments, deriving the one or more feature variables and corresponding values includes using at least one of: an engineering equation, engineering domain knowledge, plant economics equations, plant economics domain knowledge, planning and scheduling knowledge, primal and dual information resulting from an economic optimization of the underlying plant asset, a nonlinear transform, a logarithm transform, quadratic or polynomial transform, a statistical measurement over time for a time-series dataset, a calculation of a moving average value, estimates of rate of change, a calculation of standard deviation over time, a calculation of moving standard deviation, and a calculation of moving changing rate. Engineering domain knowledge can include any of: computation of a compression efficiency of a compressor, computation of a flooding factor of a distillation column, computation of internal refluxes flow, and a user defined key performance indicator for the subject industrial process. Deriving the one or more feature variables and corresponding values can include using plant economics domain knowledge. Plant economics domain knowledge can include at least one of: optimization of an underlying asset model, computation of a corresponding objective function, and the computation of all primal and dual values resulting from the solution of the underlying optimization problem.

The process model can be built using, for example, a simplified first principles model, a hybrid model, a surrogate model, or a regression model, and the process model can be trained as, for example, a clustering model, a classification model, a dimension-reduction model, or a deep-learning neural network model.

Deploying the process model can include executing the process model to monitor, predict, or perform one or more asset optimization tasks for the real-time operations of the subject industrial process. Deploying the process model and performing online PSE optimization can include self-monitoring and detection on model and PSE solution performance degradation by using one or more quantitative or statistical measurement index. Deploying the process model and performing online PSE optimization can further include auto-calibrating and auto-validating functionality and starting a model adaptation process by using available recent performance data of the system and process measurements.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram illustrating a new paradigm for asset optimization, according to an example embodiment.

FIG. 1B is a block diagram illustrating an example workflow for surrogate model generation, according to an example embodiment.

FIG. 1C is a flow diagram illustrating a method of building and deploying a model to optimize assets in an industrial process, according to an example embodiment.

FIG. 2A is a flow diagram illustrating an example method for asset optimization, according to an example embodiment.

FIG. 2B is a flow diagram illustrating defining a problem to solve, according to the example embodiment of FIG. 2A.

FIG. 2C is a flow diagram illustrating data preparation, according to the example embodiment of FIG. 2A.

FIG. 2D is a flow diagram illustrating data enrichment, according to the example embodiment of FIG. 2A.

FIG. 2E is a flow diagram illustrating model development, according to the example embodiment of FIG. 2A.

FIG. 2F is a flow diagram illustrating solution execution, according to the example embodiment of FIG. 2A.

FIG. 3A illustrates an example flow of a batch production process to produce polyacrylates in a special-chemical plant.

FIG. 3B illustrates an example of a time series of process variable measurements for a plant process contained in a generated raw input dataset.

FIG. 3C illustrates an example of hybrid modeling using combined plant batch data and first-principle model simulated data.

FIG. 3D illustrates an example workflow for building and deploying a hybrid batch process model using plant data, first-principle model and AI techniques.

FIG. 3E illustrates example plots of a hybrid model with improved product quality predictions over a data-driven only PLS model.

FIG. 3F illustrates an example of workflow for building MOP case classifier model using AI technique from historical data.

FIG. 3G illustrates an example of workflow for validating a new MOP case with a AI case classifier model.

FIGS. 3H and 3I illustrate an example of a deployed MOP PCA model.

FIG. 4A is a block diagram illustrating an example computer network environment for building and deploying a model to optimize assets in an industrial process, according to an example embodiment.

FIG. 4B is a block diagram illustrating example functional modules that can be used by the system of FIG. 4A to build and deploy a model to optimize assets in an industrial process.

FIG. 4C is a block diagram illustrating an example computer cloud environment for building and deploying a model to optimize assets in an industrial process.

FIG. 5 is a schematic view of a computer network in which embodiments can be implemented.

FIG. 6 is a block diagram of a computer node or device in the computer network of FIG. 5.

### DETAILED DESCRIPTION

A description of example embodiments follows.

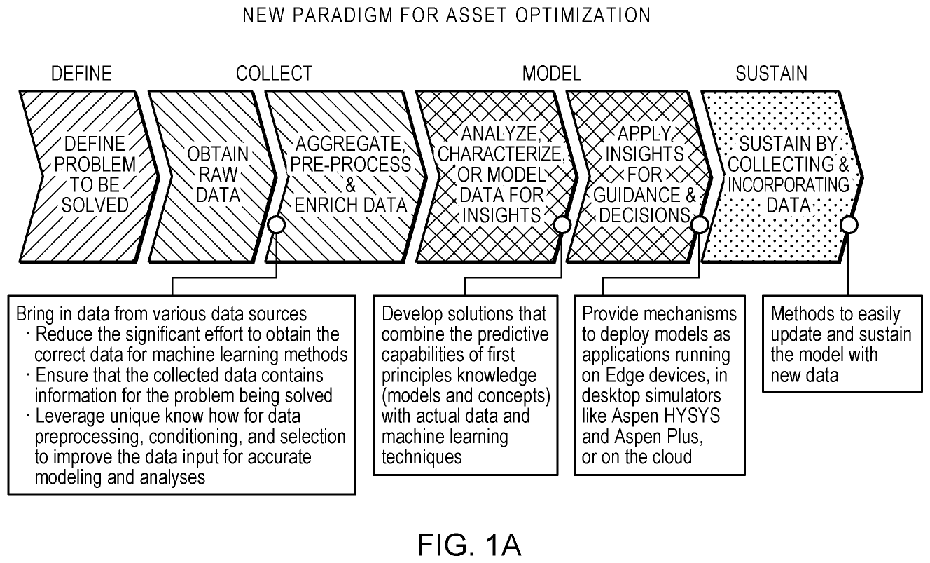

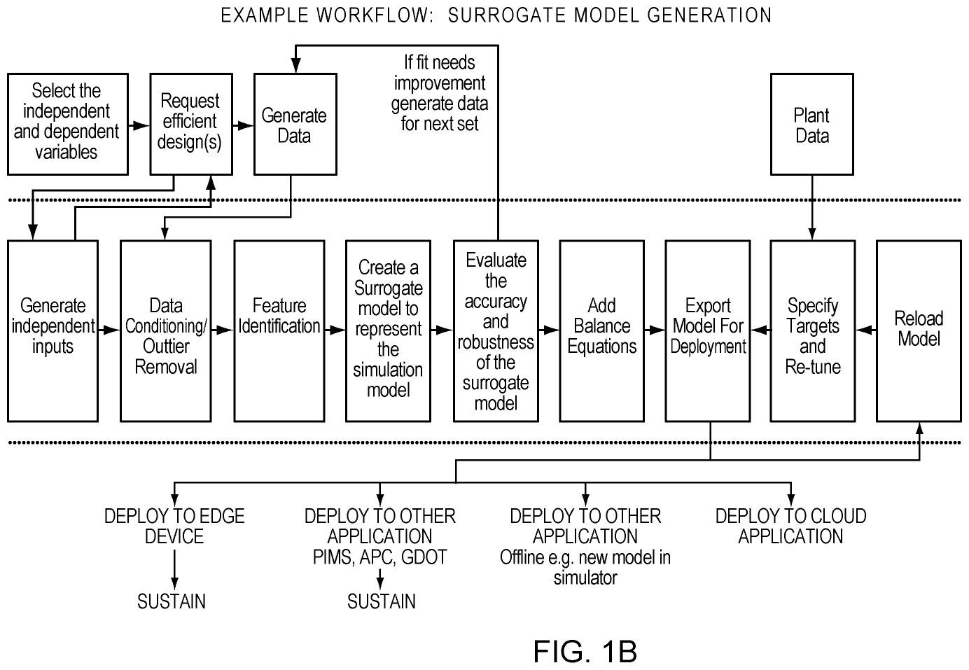

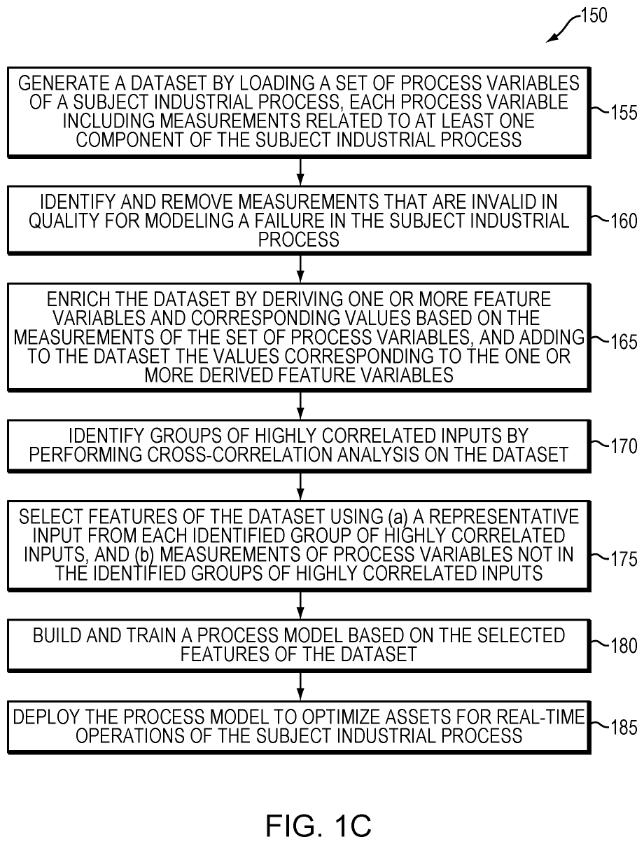

Systems and methods are disclosed for a new paradigm of Process System Engineering (PSE) practices. An example overview is provided in FIG. 1A, and an example workflow is provided in FIG. 1B. Embodiments include, for example, developing and deploying hybrid process models with both first-principle equations and process data, using embedded AI and ML techniques to facilitate and support various modeling problems and optimization solutions. The systems and methods provide a unique approach and workflow to transform traditional Engineering (ENG), Manufacturing & Supply Chain (MSC) solutions to disrupt PSE practices. FIG. 1C illustrates an example method 150 of building and deploying a model to optimize assets in an industrial process. The example method 150 includes generating 155 a dataset by loading a set of process variables' measurements of a subject industrial process. Each process variable includes historical measurement records related to at least one component of the subject industrial process. The method further includes identifying and removing 160 measurements that are invalid in quality for modeling the subject industrial process, and enriching 165 the dataset by deriving one or more feature variables and corresponding values based on the measurements of the set of process variables, adding to the dataset the values corresponding to the one or more derived feature variables. The method further includes identifying 170 groups of highly correlated inputs by performing cross-correlation analysis on the dataset, and selecting 175 features of the dataset using (a) a representative input from each identified group of highly correlated inputs, and (b) measurements of process variables not in the identified groups of highly correlated inputs in order to reduce dataset measurement redundancy. The method further includes building and training 180 a process model based on the selected features of the dataset, and deploying 185 the process model online to optimize assets for real-time operations of the subject industrial process.

In an offline debottlenecking study, a process can be analyzed to improve production that does not meet demands of quantity or specifications. A hybrid model developed with AI and ML techniques from actual plant operating data can be significantly simplified and fast-to-run that allows the process engineer to run multiple scenarios to find improvements, such as adjusting operating conditions or replacing an entire piece of equipment. Additionally, AI embedded within the model can help engineers identify root-causes where operating parameters are not consistent with design specifications.

In the case of online optimization, a process optimizer can compare various conditions and calculate a set of optimal operation setpoints to, for example, maximize profits and/or minimize costs of the asset. These online calculations are performed based on a process model and an online solver to solve an optimization problem, which can be formulated with a process model containing economic information. In previous approaches, an underlying steady-state process model is obtained from first principles knowledge and experimental data. The first principles model is calibrated or tuned to the experimental data through a manual process and must be updated on a regular basis to changing conditions. This is a time-consuming and must be performed offline. In addition, the underlying model must be highly performant and robust for the online calculations. As an alternative, hybrid models built from historical data with the help of AI and ML can be deployed online for real-time optimization with less efforts. These models satisfy the requirement of conforming to historical data. In addition, embedded ML techniques can ensure a performant and robust model, and the model can automatically self-sustain as new data becomes available. This removes the requirement of an engineer needing to re-tune or recalibrate a model offline.

In advanced process control (APC) practices, data-driven models and model-predictive-control (MPC) technology has been successfully used for decades. Although advances in APC technology have made MPC an industrial standard and the MPC controller adaptive, for a brand-new APC application, APC engineers still need to do plant tests and collect test data to build a set of MPC models for configuring and deploying an MPC controller. One way to enable the APC application to start up faster and self-grow online is to develop a “seed-model” first and then configure a MPC controller in an adaptive way, allowing the MPC controller to automatically perturb and generate new data while controlling the process production without interruptions. The “seed-model” will evolve itself as more and more new data arrives. Therefore, the way to build a useful “seed-model” for APC application in a quick and cost-effective way is a “key” for APC applications moving to next-level for asset optimization solutions. AI and ML techniques for data processing and data mining can be embedded in the embodiment to help APC engineers to train and obtain an APC “seed-model” from plant historical operation data efficiently.

In production planning and scheduling, rapid changes in market conditions often require quick-decisions and timely-adjustments on products planning and operation scheduling. For example, monthly and weekly operating plans are made for continuous production in refineries and petrochemical plants, plant management follows operating guidelines with the goal of maximizing efficiency and economic profit while operating these assets safely. Current technology in practice involves the solution of large mathematical models that represent the underlying physical assets (such as chemical reaction and separation process units) combined with supply and demand information (e.g., raw material, products, the associated economics and the like). Each application case typically involves tens of thousands of variables and equations with several thousand decisions. Recently, global supply chain considerations further complicates the problem, which encompasses multiple physical plants within a single decision-making envelope. The resulting models can be extremely large and, therefore, create a challenge to industrial practitioners and plant engineers. It would be desirable to develop and use simplified models that are fast-to-run yet accurate for refining and petrochemical planning and scheduling activities.

In process and equipment maintenance practice, unexpected failures of important equipment still happen, and the corresponding downtime may cause manufacturers big costs and loss of profits. A desirable plan of equipment maintenance should be model-based, “predictive” and “prescriptive.” A system should be able to build a model from historical data and maintenance information, predict failures in advance, and provide action guidance to prevent a process or an equipment from failures or unplanned shut-downs.

The above-mentioned problems are only a few examples in process industry; similar challenging problems and use cases have been seen in other sections of asset optimization. Recently, artificial intelligence (AI), particularly machine learning (ML) and deep-learning neural network (DLNN) approaches (techniques) are advancing rapidly and creating much excitement. For example, AI may accomplish tasks that humans do, and accomplish them much better—that is, achieve super-human performance. In the process industry, AI has also been used to attempt to solve chemical engineering problems in three phases over the last three decades (see e.g., Venkat Venkatasubramanian “The Promise of Artificial Intelligence in Chemical Engineering: Is It Here, Finally?” AIChE Journal, Vol. 65-2, pp 467-479). As described by Venkat, three previous barriers in conceptual, implementational, and organizational for AI application have diminished with rapid advances in computational power and acceptance of AI-assisted systems. There is a growing call for a manufacturing intelligence solution that makes use of the enormous amount of data in an intelligent manner. A typical successful application using deep-learning neural network model for automated plant asset failure detection was initiated (see U.S. Pat. No. 9,535,808, which is incorporated herein by reference in its entirety). Other technologies developed recently also show promise (see U.S. Pat. No. 10,031,510, which is incorporated herein by reference in its entirety).

The recent advances in AI and ML technology provide many new opportunities to address various PSE problems mentioned above and both investments and efforts are being made for improved as well as disruptive solutions in process industry. For example, there have be well-established large-scale commercial platforms (e.g., PIMS-AO™) with advanced optimization capabilities for solving planning and scheduling problems in refinery/petrochemical plants, but planning decisions still require the experience and assessment of many stakeholders from different organization departments of planning, scheduling, and process operations. To streamline and automate this process, historical information that combines the solution of planning tools as well as the actual decisions made by the stakeholders can be utilized to improve and expedite the overall planning decision making process. However, the underlying time-dependent variability in operating conditions, such as maintenance and general equipment availability and process intensity considerations, as well as exogenous conditions (e.g., price, supply and demand fluctuations) make any useful comparison of past plans a challenge. To that effect, clustering techniques in AI/ML (such as PCA and PLS models) can be embedded into the platform and combined with the inherent meta-data and the business logics available in the optimization technology presently used (e.g., PIMS). This unique combination can provide the blueprint of a hybrid production planning platform that combines traditional operations research technology that covers the fundamental physical laws (such as the conservation of mass and energy) with data driven AI/ML techniques. This framework can utilize past operating plans and lead to shorter execution times to generate monthly or weekly operating plans. It will also enable the improvement of the quality of such plans empowering less experienced planners to develop these operating plan instructions with confidence and accuracy.

Based on the considerations above, the production planning metaphor can be naturally extended to the next level below: production scheduling. An important consideration in production scheduling is the presence of discrete and real-time events that need to be fully accounted and reconciled daily. These events are transactional in nature and often require precise timing down to hours and minutes. For example, tank-to-tank transfers, pipeline receipts, and product shipments have very detailed manifest information that needs to be considered in the context of a rigorous multi-period mathematical model as well as the execution realities of daily schedules. In addition to the process models, represented through traditional mathematical forms, historical precedence and past decision-making information can also be utilized. However, the variability in plant operations, such as equipment availability as well as logistical considerations (e.g., weather events or supply delays) make any useful comparison of past vs. current plans a challenge. Clustering techniques in AI/ML (such as PCA) can be embedded in a hierarchical scheduling decision making process along with business logic extracted from operations. Historical schedule information contains decision records, simulation projections, and meta-data that can be mined to identify emerging patterns and then utilized in conjunction with the process unit models with the ultimate goal of providing more robust scheduling guidance.

For various PSE applications involving process data acquisition, model building and deployment, optimization online execution, and model sustained performance, the technology disclosed in this document provides a unique knowledge modeling paradigm and innovative methods to address several obstacles in asset optimization mentioned above.

Thus, systems and methods are disclosed for a new paradigm to develop and deploy process models based on historical data with embedded AI techniques. Various problems in process engineering system (PSE) can be addressed with a set of common procedures and steps by the following example systems and methods: A scalable process model for one or more industrial applications such as (but not limited to) process design, simulation, process analysis, online prediction, advanced control, real-time optimization or production planning and scheduling is built with first-principles, hybrid or surrogate structures, plant historical operation data and embedded AI techniques:

Configuration

(1) An example system starts with application configuration, which may include, but not limited to, problem definition, model type selection, techniques to use for a solution, and methods for model validation and results evaluation.

Data Preparation

(2) The system imports various process data including, but not limited to, plant flowsheet, such as P&ID (Piping & Instrumentation Diagram), plant operational historian (e.g., a large number of process variable measurements with time stamps), production planning and scheduling data, supply market data as well as other relevant information data, structured and unstructured, all are loaded into the system from plant asset database or other resources.

(3) The system performs data pre-processing, which includes data screening, repairing, and other preparation such as filtering, aggregation etc. An automated data screening and slicing technique (described in U.S. Pat. No. 9,141,911, for example, which is incorporated herein by reference in its entirety) can be applied to the dataset for bad data identification and data cleaning.

(4) The system continues operating on the cleansed dataset—performing feature enhancement and feature selection, which may include calculating one or more features from original (“raw”) process data and operation data, for example, applying a nonlinear transform (e.g., Logarithm) to a process variable measurements, calculating a mass balance or energy balance index, converting a vibration signal (time-series) into a frequency spectrum, running an inferential model for a property prediction value, etc.

(5) Based on results from steps (3) (4), the system selects a set of predictors from process variables and physically meaningful features by performing pre-modeling and iterative feature selections. The system may use one or more AI/ML techniques such as Principal Component Analysis (PCA) and Self Organizing Map (SOM) algorithms etc. to perform one or more iterations with automated feature selection and cross-validation.

Model Development

(6) The system then uses predictors selected from step (5) as inputs to build a process model with both domain knowledge and AI/ML techniques. The model can be a First-principle and ML hybrid model, a surrogate or reduced chemical engineering model, a dynamic deep learning neural network (DLNN) model, or a hyper-plan data-driven approximation model, etc. depending on the problem configured in step (1).

(7) Based on results from (6), the system further tests and validates the model's predictability and reliability with techniques, such as Monte Carlo simulations, cross-validation, etc. The final model can be further optimized with parameter tuning and configuration adjustment until a satisfied model performance is achieved.

Solution Execution

(8) The system deploys one or more models developed and validated in steps (6) and (7), connects all selected model inputs and outputs with plant real-time measurements, market information, production plan and schedules, real-time database, enterprise asset management (EAM) system, and the like.

(9) The system also monitors online and validates all input data flow and issues alerts when irregular data samples are detected; in some case, the system automatically repairs bad data or interpolate missing data values to maximize system up-running time.

(10) With validated input data values, the system executes one or more tasks with pre-defined problems in step (1). This may include generating online model predictions of a production quality, a projected profit, or an early detection of equipment failures, depending on the applications; the system execution may also include resolving an optimized production plan for maximum profits, an optimal equipment maintenance schedule for maximum uptime, or an adjustment of plant operation for minimum cost, etc.

(11) The system monitors its performance while generating predictions and solutions, and can perform model adaptions when model predictions and solutions become sub-optimal. In such a way, the system keeps its model and solutions updated and ensures a sustained performance.

The example systems and methods help users to complete their jobs in process modeling, simulation, design, or real-time optimization, advanced control, and production planning and scheduling, etc. in an easy workflow with the new paradigm, and facilitates the asset optimization with integrated domain expertise and AI techniques. As a result, long-term sustained safe and optimized operation and production are achieved, which support manufacturers pushing their assets into a sustained performance—improving safety, managing risk, reducing downtime, enhancing productivity, and maximizing profitability.

These example systems and methods can include one or more following steps:

(1) Define problem to be solved: To solve a traditional PSE problem, the PSE problem need to be well defined first. The problem can be, for example, building a model to simulate current production process for performance analysis and debottlenecking, a model-based Model Predictive Controller design, a real-time production planning & scheduling solution, or an online model deployment for process and equipment failure prediction. Process information and model parameters are provided and one or more of following items can be determined: (a) A Model Structure (e.g., a first-principle equation-based model, a simplified or surrogate model, a data-driven empirical, or a hybrid model); (b) An Objective Function (e.g., a scalar value able to measure the ultimate operation goal to be minimized or maximized); (c) Various Constraint Conditions reflecting market and plant operation realities need to be satisfied; (d) Criterion for Solution Convergence; (e) Algorithms to use to solve the defined problem; and (f) Representative properties in the solution.

(2) Obtain process data: For one or more PSE problems, to begin model development or calibration, a large number of process measurements from plant operational historian need to be loaded into the system; for example, a plant piping and instrumentation diagram/drawing (P&ID) information can be displayed in a user interface (UI) for a user to view and select the list of process measurements as candidate inputs (tags), or the user can manually type in the first one or two characters of an process unit name or tag group name (e.g. 02CUD*) for a tag search, in which all available tags in the database can be filtered under the hood and those relevant tags are listed as candidates for user's selection. With this approach, the model configuration is significantly facilitated. Alternatively, the system can also import plant historical data from other data servers or spreadsheet files.

(3) View and Screen Data: Once the source data is loaded/imported into the system in step (2), a dataset consisting of a large number of process variable measurements from plant historian is retrieved; An auto-data-slicing technique (see e.g., U.S. Pat. No. 9,141,911) can be applied to the selected dataset for an automated data cleansing; all missing data (e.g., gaps), freezing signals (constant values crossing over the whole history), and outliers will be detected and marked as candidate variables to exclude. Optionally, the data screening results are also displayed to the user in the UI for optional removal confirmation.

(4) Repair missing and bad quality data: The system provides flexibility for user to pre-process data with several processing options: (a) Interpolation—fill in data gaps with interpolation; (b) Filtering—applying non-phase-shift filters to selected noisy process measurements for data smoothing; (c) Model based data repairing—replace outliers, gaps and other identified bad data segments with internal model produced values; and (d) Resampling data—up-sample original time-series data with snapshots or average as options, or down-sample data with interpolated values.

(5) Aggregate and Enrich Data: The system provides an approach for aggregating data based on an optimal sampling rate for the model building or solution search, and also performing feature engineering using the available measured inputs of the dataset to derive feature variables and corresponding values (feature inputs). Through data aggregation and feature engineering, the embodiments generate an enriched input dataset from the original input dataset. To do so, the embodiments apply an automated data enrichment procedure to derive the feature inputs from the measured inputs in the raw input dataset, which are added to the original input dataset. The embodiments enrich the input space (the original raw dataset) using feature engineering, which generates values for one or more derived feature variables possibly more predictable to a target output than values for measured input variables. The embodiments can derive the feature variables and corresponding values (inputs) either based on physical principles or numerical transforms, for example, by applying a logarithm transform to values of a measurable input variable (measured input) of the dataset, or by applying a Fast Fourier Transform (FFT) on to a machinery vibration signals for a frequency spectrum analysis, or by calculating a new input variable using a math equation on one or more measured input of the dataset. The derived feature inputs are then added to the dataset and together with the measured inputs form an enriched dataset. Using AI and ML techniques, the embodiments may further perform cross-correlation analysis among all inputs of the enriched dataset, including both the measured and derived feature inputs. The cross-correlation analysis identifies highly correlated inputs of the dataset and groups them to limit these highly-correlated (redundant) inputs from all being selected as final inputs to the model or solution. The embodiments also provide input-output model fitting analytics as well as AI/ML techniques such as PCA, PLS algorithms to test and drop from the enriched input dataset measured inputs and/or derived feature inputs that show no or relatively less correlations with a selected output. As a result, the embodiments provide results with a significant input dimension reduction on the original input dataset through multiple techniques. The embodiments may also build Principal Component Analysis (PCA) models or Projection Latent-Structure (PLS) models with AI algorithms to convert all or part of inputs into a set of independent lower-dimension latent variables as inputs.

(6) Build Process Models: One or more process models are built based on the selected PSE application problems. For example, for an online plant optimization purpose, a hybrid model between a simplified first principles model (FPM) or a surrogate model and an embedded empirical ML model may be more appropriate than a full scale of FPM; for a real-time refinery planning and scheduling application, a “hyper-plan” ML approximation model may be appropriate, which is trained from plant operation data and simulated data based on a high fidelity refinery FPM model; for an APC project, a “seed-model” can be obtained by a system identification from plant historical data and embedded AI data mining algorithms; for an equipment failure predictive analytics, a deep learning neural network (DLNN) model trained from past failures and normal operation data may work well, and such. For any one of these applications, the model development may follow the common steps provided in the disclosed methods: (a) Select a Model Structure (e.g., a first-principle equation-based model, a simplified or surrogate model, a data-driven empirical model, or a hybrid model); (b) Determine an Objective Function (e.g., a scalar value to be minimized or maximized); (c) Specify various Constraint Conditions need to be satisfied; (d) Decide a Criterion for Model Convergence; (e) Select Algorithms to use to solve the defined problem; and (f) Choose Representative Properties in the solution. Based on a set of specifications listed above for the model development, one or more models can be built with first-principle equations, cleaned and enriched plant data, AI/ML models through various steps, such as data reconciliation, model calibration, process simulation, dimension reduction, data clustering, and classification, prediction, and cross-validation, and so on. At the end, one or more validated models and application solutions can then be deployed online.

(7) Deploy a model or execute solution online: For a deployed process model or a model-based solution, the embodiments can provide the following methods and execution steps to support successful applications: (a) Monitor and receive real-time plant data through data server or network; (b) Run data validation to ensure fresh real-time data are connected and received properly without irregular or missing values; (c) Apply data imputation or sensor re-construction algorithms to repair missing and invalid data when necessary; (d) Perform feature calculation and extractions required by model inputs, such as applying transforms to raw data, compute derived variable values from measurements, running through inferential models to generate property estimated values, etc.; (e) Execute model predictions and solve optimization problems online for the ultimate application solutions at a repeated cycle; and (f) Export model prediction and solution results for decision making or real-time process control and optimization implementation.

(8) Performance monitoring and model adaptation: Embodiments can include a set of methods of performance monitoring and self-model adaptation to support sustained performance of the system. The methods can include: (a) A pre-defined key performance indicator (KPI) of model quality or optimizer performance measure, which is used to evaluate the current performance of a model or a solution based on recent process data; (b) A baseline of the values of model KPI for comparison and poor-performance detection; (c) A self-diagnosis and performance assessment system is also provided in the embodiments for detailed analysis of the degraded performance; for example, the root-cause of a system's poor performance can be an out-of-date sub-model, or a sub-optimal parameters that need to re-tune; (d) A set of model adaptation algorithms and procedures to update a process model accordingly once a model KPI measure becomes poor and a criterion threshold for system adaptation has been reached; and (e) A periodical execution of model performance monitoring and adaptation.

In practice, the systems and methods disclosed herein may contain multiple models and solutions, and they can be developed and deployed in one or more computer servers and run simultaneously. Alternatively, the systems and methods may also be implemented in a cloud environment, which allows process operators and engineers to operate and optimize their plant remotely with great convenience and efficiency.

The following describes an example system for building and deploying a model and solution to optimize assets in an industrial process.

Overview

To achieve asset optimization, process model development has been as an effective tool applied to plant design, simulation and process analysis such as retrofits, revamps, and debottlenecking, etc. Further model online deployments also showed good potentials in real-time process optimization, production planning and scheduling, model-predictive control, and asset failure prediction and prevention etc. applications in the process industry, such as at refineries and chemical or petrochemical plants. Although process engineers have made big efforts over the last three decades, those previous application efforts have been focused on developing either traditional full-scale first-principle models or typical plant-test data-driven empirical models. The success of those online applications in process industry have been heavily limited by their complexity and high cost to sustain. Recently, there is increasing interest in developing applications that use artificial intelligence and machine learning with big data. This provides a new promise to chemical engineers and asset optimization practitioners in process industry.

In practice, major difficulties in prior arts for a process system engineering (PSE) application in industrial practice came from the following: (1) complexity of full scale first-principle models; (2) too many model parameters need to tune or calibrate; (3) plant data are noisy, usually are neither sufficient (for a full scale model development) nor yet ready for use; (4) simplified models as an optional choice, may overcome some of the difficulties mentioned in (1)-(2), but their performance on predictive accuracy and model extrapolation may suffer; (5) pure data-driven empirical models showed successful applications in APC, but are still limited on linear models and relatively simple nonlinear cases; (6) applications in process or equipment failure prediction and prescriptive analytics are just started; and (7) most applications are still lack of an online self-monitoring and adaptation. Most importantly, a new systematic paradigm is not yet established in prior arts for an integrated solution with embedded AI and a set of system and methods are needed to address all challenges listed above.

The systems and methods disclosed herein provide a new paradigm to address the above obstacles with an innovative approach that combines traditional first-principles modeling approach and modern AI and ML algorithms in a flexible framework.

Asset Optimization Work Flow (100)

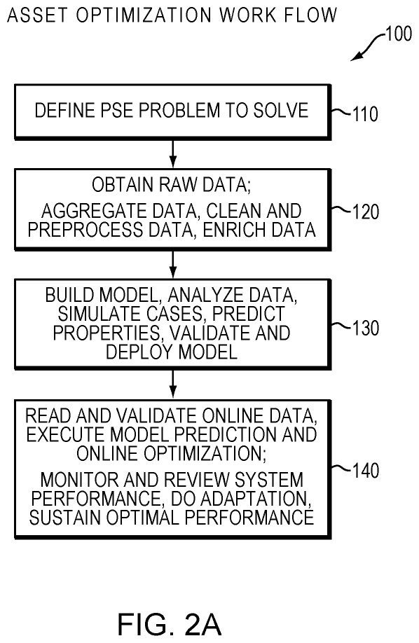

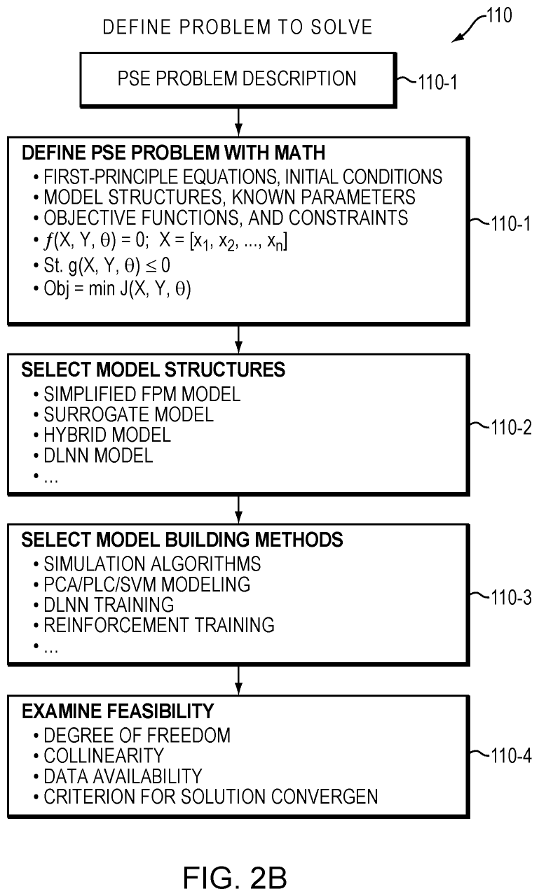

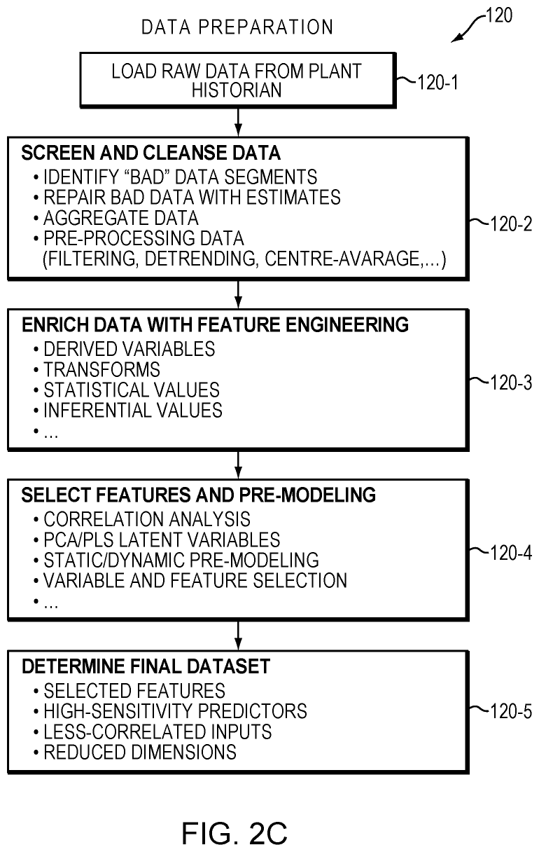

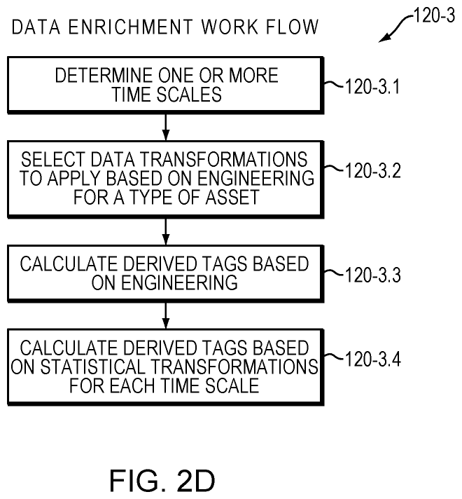

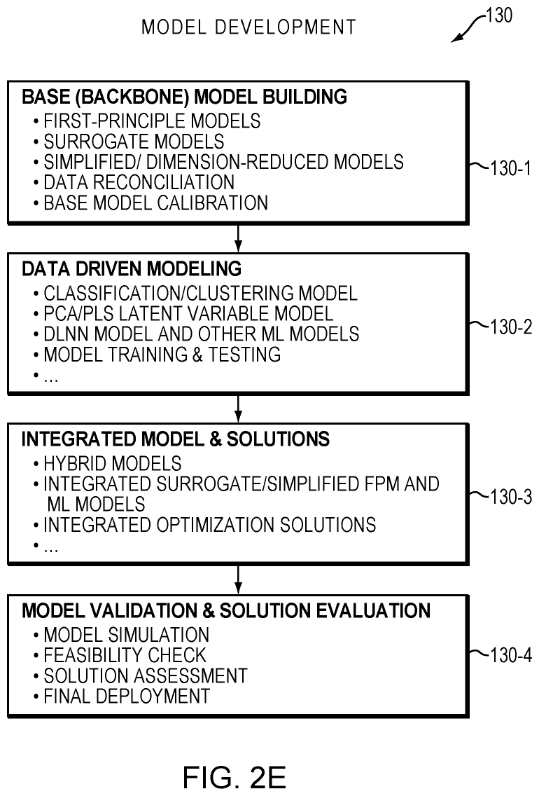

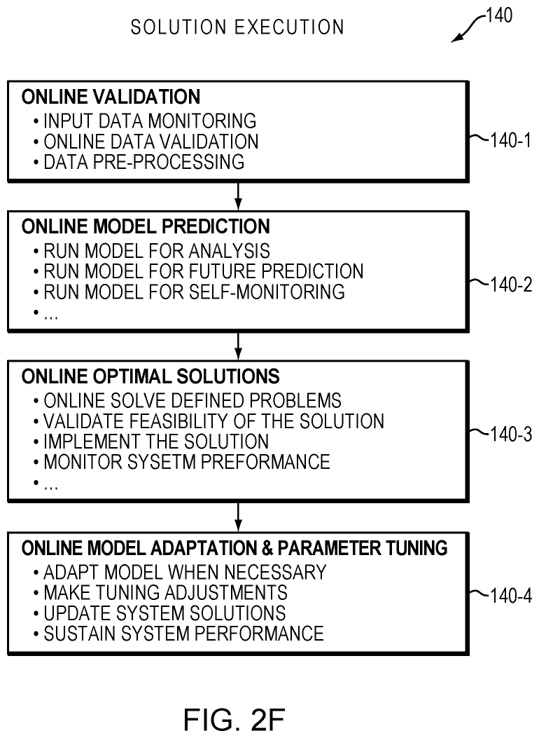

FIG. 2A illustrates an example method 100 of building and deploying a scalable process model and solution for an online asset optimization application. To build the model and solution, the method 100 first defines 110 a PSE problem with model type, optimization target, and application scope information. Then, various process data are obtained 120 by importing P&ID plant design data, and loading plant historical operating data. An improved dataset is generated by aggregation, data cleansing, and pre-processing 120. The improved dataset may contain original recorded measurements of process variables, enriched feature variables (derived variables), or both for the subject plant process. To generate the improved dataset, the method 100 effectively enriches the measurements of the original process variables and then reduces the formidable number of measurements, as well as values of derived variables, for the subject plant process to a set of key inputs of plant process model. Using the selected inputs data and defined model type and PSE problem, the method 100 includes building 130 one or more models with, for example, data reconciliation and parameter calibration (for a FPM or hybrid model/sub-model), linear regression or system identification (for a linear dynamic APC model/sub-model), dimension-reduction and classification (for an AI model/sub-model), or DLNN training (for a ML model/sub-model). The method 100 further includes validating the model and solution through simulation and prediction, and then deploy the model and solution online for a real-time implementation. Once the PSE model and solution are deployed online 140, fresh real-time process data can be received from a plant at each execution cycle. The method 100 can execute data validation before creating model predictions and make data repairs when necessary, then model prediction and asset optimization tasks may be performed. The results are sent to plant for implementation. In addition, the method 100 can involve self-monitoring 140 on its performance in recent history. In case a production plan/schedule is changed or environment varied, and degraded system performance detected, the model adaptation or parameter tuning tasks can be used to maintain sustained performance.

Define Problem (110)

With reference to FIGS. 2A and 2B, the example method 100 begins at step 110, which may include suitable or certain initialization of the PSE problem definition. A typical PSE application problem includes, but is not limited to, one or more mathematical equations describing a process consisting of many variables, among which some are manipulate variables (such as crude oil feed flow and heating temperature) that can be used to drive and control the process operation, some are state variables that are indicators of the process current condition (such as operating temperature and pressure), some are dependent variables (such as product quality and draw-rate). The complex relations linking all three kind of process variables are represented in a model, and all relevant physical and chemical operating boundaries can be formulated as constraints equations. For example, in step 110 (at 110-1), a typical PSE process can be represented mathematically as following:

f(X,Y,θ)=0; X=[x₁,x₂, . . . , xₙ] (Eq. 1a)

St.g(X,Y,θ)≤0 (Eq. 1b)

Where X contains all manipulate and state variables, and Y represents one or more dependent variables, θ is a vector of model parameters, and f(.) and g(.) are general functions representing relations between X, Y, and θ. In step 110 (at 110-1), the embodiments also specify process initial conditions X₀, Y₀ and known (or estimated as default) process parameter values θ=θᵢₙₜ.

Additionally, an objective function is also defined at step 110-1, which may be a goal to be minimized (such as cost, waste emissions and operation risks etc.), or a quantity to be maximized (such as production rate, operation efficiency, and total profit etc.) depending on the underlining problem to solve, as shown in Eq. 1c below:

Obj=min J(X,Y,θ) (Eq. 1c)

In step 110 (at 110-2), the embodiments allow and assist a user to select a model structure most appropriate for the specific problem defined in step 110-1. It may be a simplified model from a full-scale first-principle model, a surrogate regression model, a hybrid model combining first-principle knowledge and empirical model from process data, or an AI or ML model, depending on specific application requirements (such as tolerable model complexity, acceptable model accuracy of simulation and prediction, and availability of process data required for training and validating a model, etc.)

In step 110 (at 110-3), the embodiments assist the user to select one or multiple model building methods for the most appropriate model structures selected in step 110-2. The system provides various method options for model building and allows the user to try different approaches, described in step 130, for a best solution.

The embodiments, at step 110-4, may further assist user to examine feasibility and validate the selected model type at step 110-2 and model built at step 110-3. These validations may include, but are not limited to, degree of freedom check, inputs collinearity analysis, data sufficiency assessment and feasibility examination of the selected criterion for the problem and solution convergence, etc.

Load Process Data (120)

With reference to FIGS. 2A and 2C, the example method 100, at step 120-1, loads historical and real-time operations data (measurements) for process variables of the subject plant process from a plant historian or asset database. In other embodiments, the method 100 (at step 120) may load (import) operations data for the subject production process variables from other sources, such as plant P&ID and design data, other plant data servers, plant management systems, or any other resources of the plant. In yet other embodiments, the operations data may be loaded from a file with data format, including a spreadsheet file, a text file, a binary file, and the like. The loaded operations data includes continuous measurements for a number of process variables (process variable tags) for the subject production process, as, typically, measurements for hundreds or even thousands of process variables are stored in the plant historian or plant asset database over time for a production process. The method 100, at step 120, generates a raw dataset that contains the loaded original operation data (measurements) for the process variables of the subject process, formatted as a time-series based on timestamps associated with the operations data.

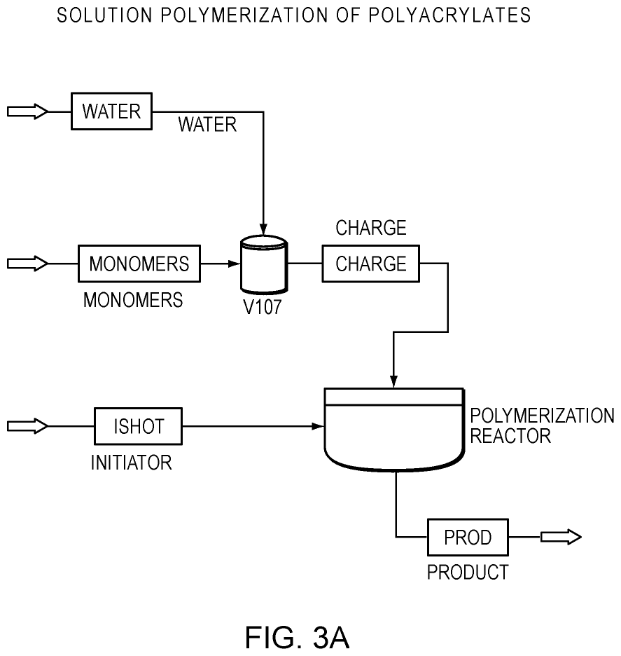

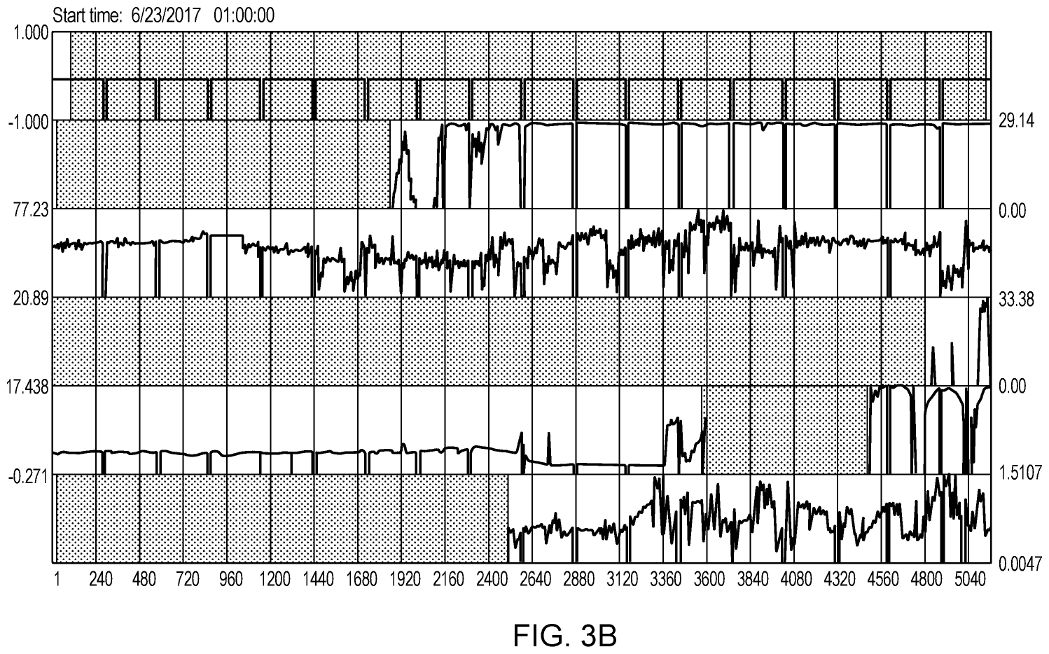

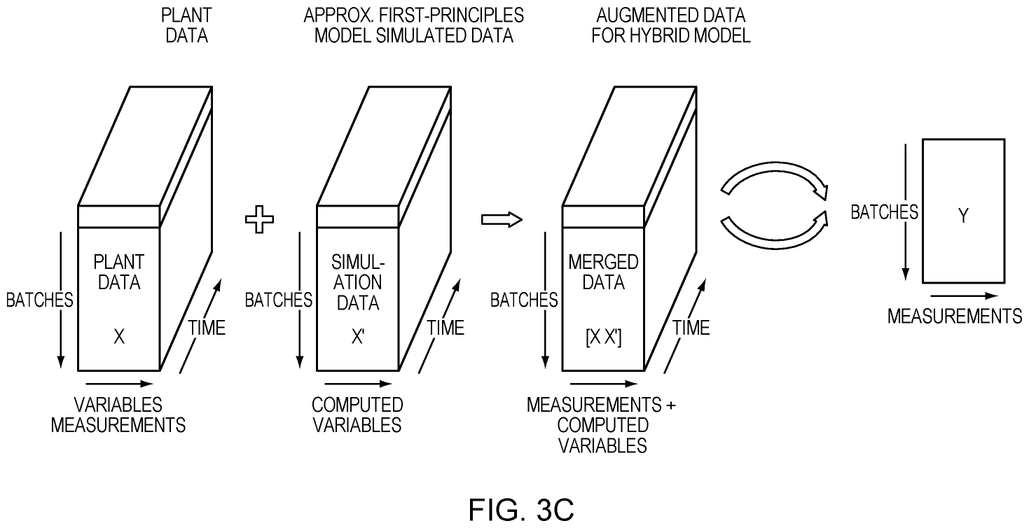

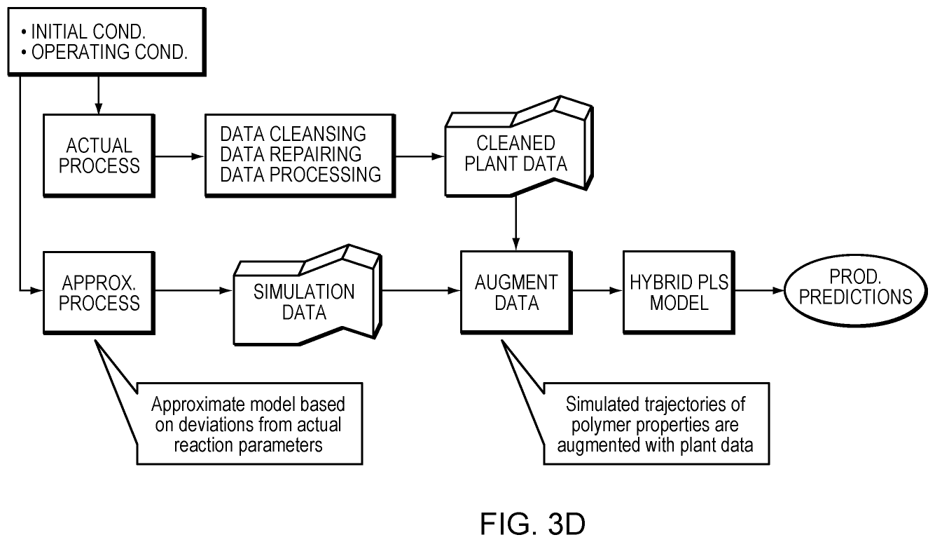

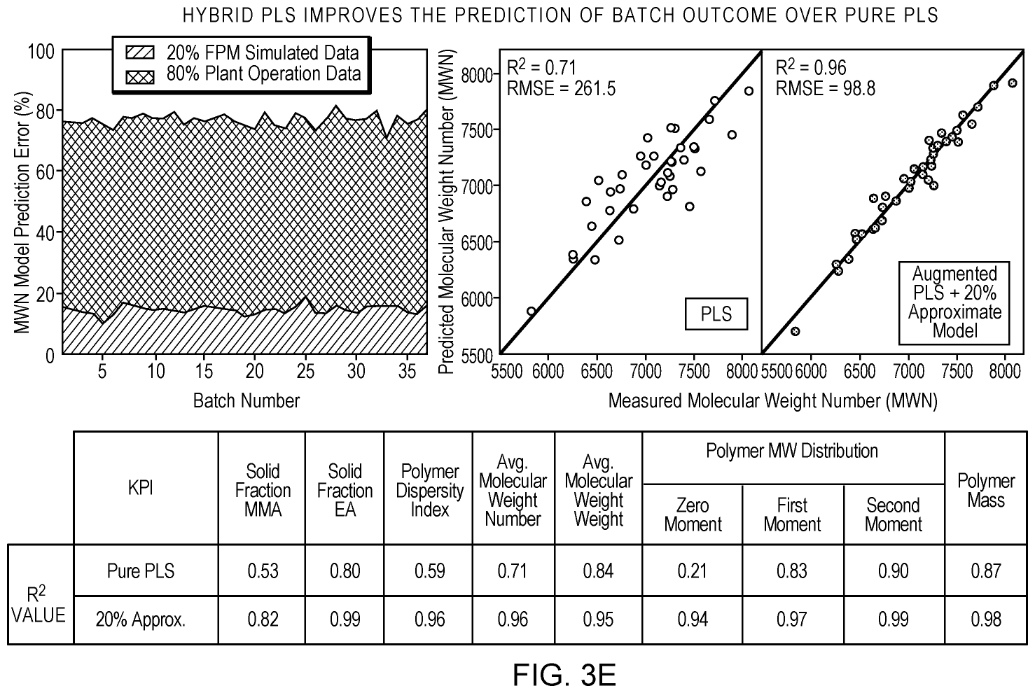

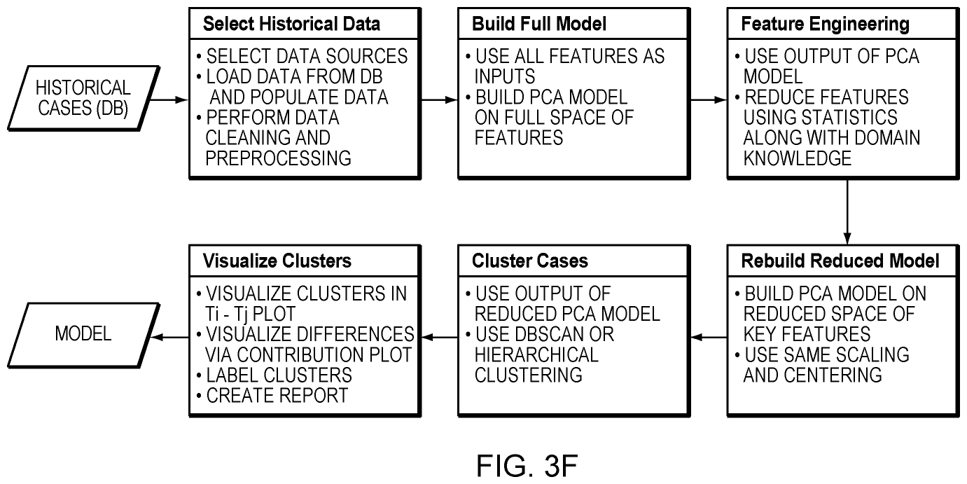

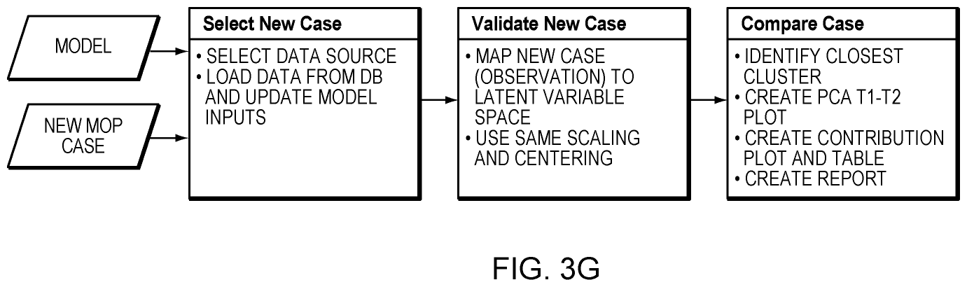

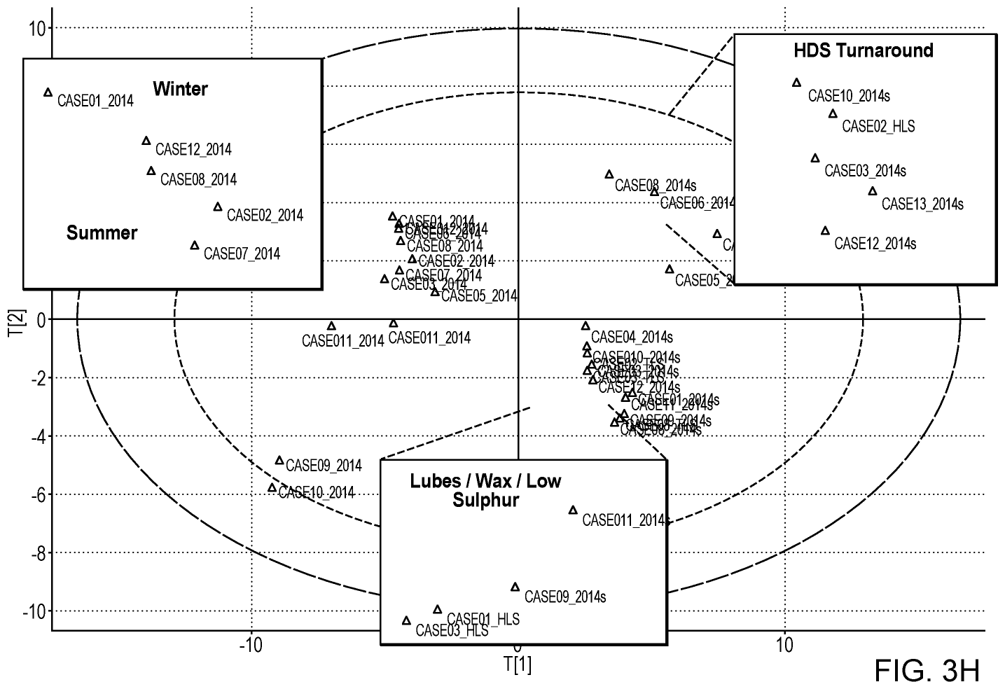

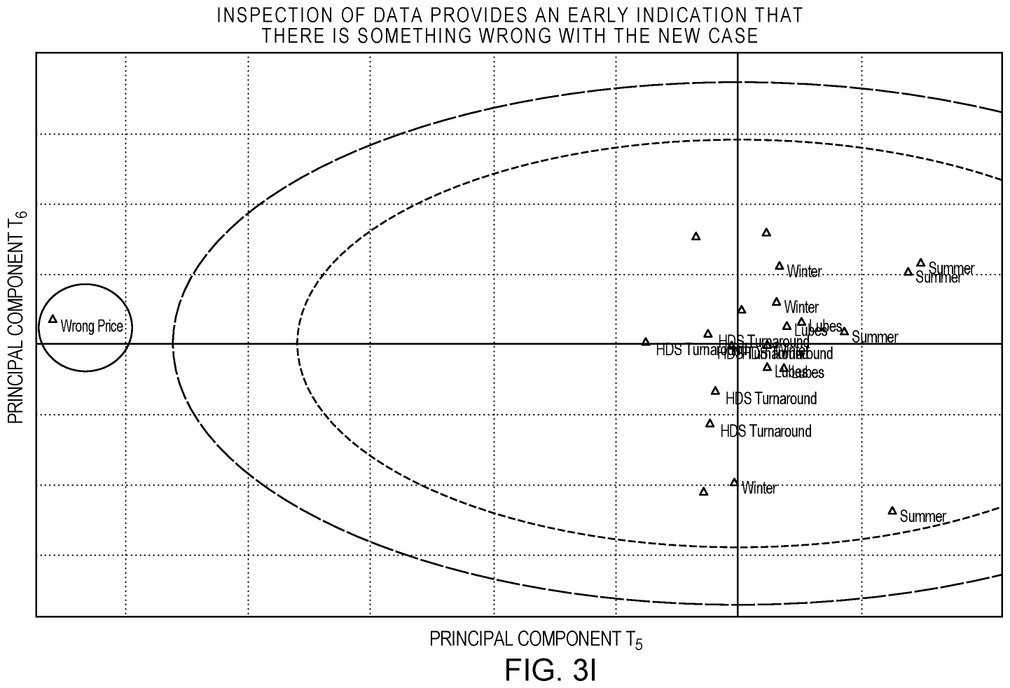

The method 100, at step 120, generates a raw input dataset that contains the loaded operation measurements for the selected candidate process variables of the subject process, formatted as a time-series based on the associated timestamps. FIG. 3B is a time-series graph depicting an example dataset of operation measurements loaded from a plant historian database for the candidate process variables. FIG. 3B illustrates the continuous operation measurements for each of the large number of candidate process variables.

Repair and Cleanse Dataset (120-2)

The method 100, at step 120-2, performs data cleansing and repair on the raw input dataset generated in step 120-1. In example embodiments, the method 100, at step 120-2, applies an automated data screening and slicing technique for identifying and cleansing the generated dataset. In some embodiments, the method 100, at step 120-2, applies the automated data screening and slicing technique described in U.S. Pat. No. 9,141,911.

For each candidate process variable of the dataset, the method 100, at step 120-2, screens the process variables' continuous measurements, and identifies measurement data (partial and whole) that is of bad quality (invalid) for modeling and predicting one or more process properties associated with the subject plant process. The method 100, at step 120-2, automatically marks the identified measurement data for possible exclusion from the dataset. The identified bad quality measurement data for a candidate process variable includes, but are not limited to, missing values (gaps), frozen signals (constant values crossing over the whole history), short-term outliers, and values are out of process in high/low process limits or highly noisy in the continuous measurements of the candidate process variable. The method 100, at step 120-2, may identify and mark bad quality measurement data of a candidate process variable based on data sample status, recorded value quality, known sensor interruptions, process downtime, operational high and low limits, as well as calculating statistics on the continuous measurement data (as loaded from plant historian database in step 120-1). The calculated statistics for a candidate process variable include, but are not limited to, mean, median, standard deviation (STD), histogram, skewness, and kurtosis.

The method 100, at step 120-2, provides flexibility to pre-process the marked bad quality measurement values of the dataset with several repair and removal processing options to cleanse these values. In some embodiments, the method 100, at step 120-2, displays the marked bad quality measurement data to the user, via a user interface, and enables the user to select or confirm cleanse or repair options to apply to the marked measurement data.

In some embodiments, the method 100, at step 120-2, may repair some or all of the marked bad quality measurement data for the candidate process variables in the dataset. In cases of missing measurement values (gaps) for a candidate process variable, the method 100, at step 120-2, may fill-in the gaps in the continuous measurement data with interpolation. In cases of outliers, gaps, and other bad data segments in the measurement data for a candidate process variable, the method 100, at step 120-2, may apply model-based data repair to replace these bad data segments with internal model-produced measurement estimation values. The method 100, at step 120-2, may also repair relatively short slices of bad values, gaps, frozen signals, and the like for a candidate process variable by using principal component analysis (PCA) or subspace modeling and sensor validation algorithms, as described in U.S. Pat. No. 9,141,911.

In cases of noisy measurement values for a candidate process variable, method 100, at step 120-2, may improve data distribution by applying non-phase-shift filtering to data (de-trend, resample, up-sample, down-sample, and such) portions of the measurement data containing drafting or noisy values for synchronization. The method 100, at step 120-2, may aggregate the raw data by resampling or down-sample measurement values for the candidate process variable with values taken from snapshots or calculated time-center averages of the measurement values, or up-sample measurement values for the candidate process variable with interpolated values. The method 100, at step 120-2, may also prepare the measurement data with pre-processing options, such as by re-sample the measurement data for a candidate process variable at a-sample-per-minute to a-sample-per-hour using a “centre-average” or “filter-smoothing” technique.

A “Centre-average” value can be calculated with the following formula:

$$\overline{y} ( t ) = \frac{1}{2 n + 1} {\sum }_{i = - n}^{n} y ( t + i )$$

where 2n+1 is the width of a time window.

The “filter-smoothen” technique filters the original time series two times, one forward and the other backward with a smoothen filter, such as a first-order filter:

y̅(t)=α×y̅(t−1)+(1−α)×y(t−1)

where (0<α<1)

In some embodiments, the method 100, at step 120-2, may cleanse (remove or slice) bad quality (invalid) data measurements or a subset of candidate process variables from the dataset. In example embodiments, method 100, at step 120-2, may select and remove measurements of a set of candidate process variables in the dataset that are non-informative to one or more process properties of the subject process. For example, the measurements of the selected set may have long-time constant values (flat lines in a time-series plot), a large portion of missing values (gaps), and the like. In some embodiments, the method 100, at step 120-2, may compare the measurements of each candidate process variable to identify and eliminate from the dataset the candidate process variables having fewer good measurement values and less information related to one or more process properties.

In some embodiments, the method 100, at step 120-2, may eliminate process outliers in measurements. For example, the method 100, at step 120-2, may apply a dynamic floor and ceiling across the dataset for outlier detection and removal from the measurement data.

FIG. 3B illustrates an example of a time series of process variable measurements for a plant process contained in a generated raw input dataset. The X-axis is time, shown in number of samples, the Y-axis is sensor measurement values. The measurements indicated by dotting are samples identified and marked as example bad data sections and non-informative measurements identified by method 100 at step 120-2, which may be removed from the generated dataset.

Perform Data Feature Enrichment (120-3)

The method 120, at step 120-3, then performs data feature enrichment on the cleansed/repaired input dataset resulting from step 120-2. The feature enrichment enhances the dataset by adding physically meaningful or numerically more relevant derived process variables and corresponding values. Step 120-3 automatically derives various feature variables and corresponding values from the measurements of candidate process variables in the dataset. The derived feature variable values may be more predicative of the identified at least one process dependent variable of the subject plant process than the measurements of candidate process variables in the dataset. Step 120-3 may derive the feature variables and corresponding values using engineering transform equations. These equations may correspond to specific process or units (equipment) having measurements in the dataset. For example, step 120-3 may derive feature variables' values by transforming the measurements of candidate process variables in the input dataset (e.g., computing logarithm of measurements, computing quadratic or polynomial values of a measurements, and the like). As another example, step 120-3 may derive feature variable values based on computing engineering knowledge-based virtual values based on measurements of candidate process variables in the input dataset (e.g., computing a compression efficiency of a compressor, computing a flooding factor of a distillation column, computing internal refluxes flow, and the like). As a further example, step 120-1 may derive the feature variables' values by computing statistical measurements based on the measurements of candidate process variables in the input dataset (e.g., calculating a moving average value (MVA), estimating derivatives or rate of change, standard deviation over time (STD), moving standard deviation (MVSTD), moving changing rate, and the like).

The method 120-3 adds the derived features values to the dataset (from step 120-2) to generate an enriched dataset. The size of the input dataset is temporarily increased by adding the enriched feature variables' values. However, the enrichment of the input space (input dataset) by adding the feature variables' values are proven helpful in building an improved model for predicting a process property of the subject plant process.

To perform input feature enrichment, the method 120-3 may use the example method 120-3 illustrated in FIG. 2D. The method 120-3, at step 120-3.1, first determines an appropriate time scale of measurements for candidate process variables (candidate process variable measurements) in the cleansed dataset. The time scale can be selected for achieving optimal modeling, and is mostly dependent on process type and domain knowledge. In example embodiments, therefore, the time scale may be defined according to a user-specified value or a system default value (e.g., in minutes, hours, days, weeks, months, or years). At step 120-3.2, the method 120-3 then requests a user to select engineering transform equations, or uses default engineering transform equations for a specific process unit, such as a distillation column, a furnace, a compressor, a pump, and the like. The method 120-3, at step 120-3.3, next automatically derives tag values or virtual input values for the specified process unit based on the selected/default engineering transform equations and the measurements of the specific process unit in the dataset. At step 120-3.4, the method 120-3 further derives statistical feature tag values for the specific process unit based on the selected/default statistical equations and the measurements. The derived tags or virtual inputs of step 120-3.2 and derived statistical feature tags of step 120-3.4 are referred to as enriched feature variables. The method 120-3 adds the values of the enriched feature variables to the input dataset to generate a feature enriched input dataset.

Perform Cross-Correlation Analysis on Enriched Dataset (120-4)

The method, at step 120-4, performs data cross-correlation analysis on the cleansed/enriched input dataset resulting from step 120-3. The cross-correlation analysis facilitates identifying and grouping highly correlated inputs (including both measurements of process variables and values of derived feature variables) in the cleansed/enriched dataset.

To perform the cross-correlation analysis, the method at step 120-4 analyzes each pair of inputs (measurements of process variables and values of derived feature variables) in the cleansed/enriched input dataset. As any pair of inputs in the input dataset may change with a possible time delay, the method at step 120-4 specifies a time window (interval) having a width capable of covering the longest possible time delay between a pair of inputs in the input dataset. The method at step 120-4 selects the time window to cover time delay and dynamic transactions in the behavior of the subject process between any pair of inputs. By selecting such a window, the method at step 120-4 may capture and analyze on the inputs that may not be well synchronized natively.

The method at step 120-4 then performs a dynamic cross-correlation analysis (function) over the specific time window. Different from the calculation of a conventional correlation coefficient between two variables, the dynamic cross-correlation function estimates a set of cross-correlation coefficients over the specified time window for each pair of inputs of the input dataset based on the entire length of time series data for the input measurements. The dynamic cross-correlation function estimation results in a short time series segment of estimated cross-correlation coefficient values for each pair of inputs over the time window. The method at step 120-4 next determines a maximum cross-correlation coefficient value for each pair of inputs (in magnitude) by plotting/searching over a trend curve between the pair using the respective cross-correlation coefficient values. For each pair of inputs, step 120-4 may normalize the cross-correlation coefficient value of the pair to a score (e.g., a value between 0.0 and 1.0).

The method at step 120-4 then compares the calculated maximum cross-correlation coefficient value or score of each pair over the correlation time window to a defined global correlation threshold value or thread (e.g., default value, thread=0.9, and the like). In different embodiments, a cross-correlation coefficient value does meet the defined global correlation threshold value, when the cross-correlation coefficient value is greater than the threshold. Based on the comparison, the method at step 120-4 determines whether a pair of inputs is highly correlated and, if so, the two inputs will create a new or join an existing highly-correlated input group. Within such a highly correlated input group, each joined inputs of a pair show high correlations to other joined inputs. For example, if the maximum correlation coefficient value for a first pair of inputs reached a value greater than the correlation threshold (e.g., r=0.9), step 120-4 may determine that pair is highly correlated and group the pair.

Feature Selection Through Pre-Modeling

The method, at step 120-4, removes (prunes) some process variables from the input dataset based on cross-correlation analysis results. To do so, only one variable is kept from each highly correlated group and other variables are dropped. Then the method at step 120-4 may further reduce the number of input variables by another ML technique. To do so, the method at step 120-4 builds a multivariate statistical model, such as a Principal Component Analysis (PCA) model or Projection-to-Latent-Structure (PLS) model for significant input-space reduction. PCA and PLS models are capable of handling high-dimensional, noisy, and highly correlated data, such as the measurement data of the candidate process variables and enriched feature variables of the subject process.

The method at step 120-4 builds the PCA or PLS model using the measurements of the remaining input process variables (i.e., remaining after the eliminations through cross-correlation analysis in step 120-4) as model input for a PCA (unsupervised ML) model and one or more process dependent variables as model output for a PLS (supervised ML) model. The method at step 120-4 executes the building of PCA or PLS model to validate and transform the candidate process input variables (model inputs) into a projection latent structure. To do so, the PCA or PLS model projects the measurements of the candidate process variables onto a lower-dimensional subspace (e.g., generate a small set of latent variables) that contains most of the covariance information between the originally input data of the subject process (PCA) as well as the covariance information between inputs and outputs (PLS). Based on the projection, the built PCA or PLS models maps the higher dimension input variables onto the lower dimension latent variables, while providing the information of statistical contributions (contribution coefficients) from each candidate process variables to the dependent variables in terms of magnitudes and directions. The PCA or PLS model provides the respective statistical contributions (contribution coefficients) in a ranked order of the candidate input process variables, and mapped to the projected latent variables which represent most of the variances among the inputs (PCA model) and the co-variances between of the inputs and outputs (PLS model). The PCA or PLS model is structured as: X=T P^{T}+F, Y=TQ^{T}+E, where prediction error, E(n) is a function of number n, initially reduces with the increase of latent variables (n), but E(n) then saturates when the number of latent variables (n) reached a certain level.

Based on the ranking, the method at step 120-4 selects only the candidate process variables having large contribution coefficients and higher statistical confidences in predicting dependent values for the dataset. That is, based on the ranking, the method at step 120-4 further removes the candidate process variables having contribution coefficients showing insignificant statistical contribution from the dataset to generate a further reduced dataset.

The method at step 120-4 can allow a user to involve the variable selection process. The built PCA or PLS model may return a set of ranked process variables according to the model statistics. Based on the ranking, the method at step 120-4 may plot the model contribution coefficients in a graph/chart on a user interface. Through the user interface, a user may view and prune process variables showing insignificance in predicting dependent variable values from the dataset. After step 120-4, only a subset of the originally process variables in step 120-1 and feature variables in step 120-3 (e.g., starting from 200+ tags downsize to subset of 50 tags) remain in the reduced dataset. The method at 120-4 provides the reduced dataset as model input to build a final model for the subject process.

In an example embodiment, as an alternative, the method at 120-4 may export a small subset of the projected latent variables (e.g., mathematically equivalent to a set of transformed new variables) from the PCA or PLS model for use as “transformed” final model inputs (instead of the larger number of process variables) to build the model. The method, at step 120-5, may generate the reduced subset by truncating the projected latent variables from the PCA or PLS model using a best trade-off between model fitting and simplicity. The projected latent variables have many good properties (e.g., mathematically independent of each other, contain enriched information for modeling, and the like) that are superior for building a model than properties of the reduced process variables. The reduced subset of the projected latent variables can represent most of the useful correlation information needed to facilitate the modeling efforts. In this way, the PCA or PLS model act as a “data transform and compression” module and a “pre-filter” module with respect to the set of latent variables used as input to build a final PSE model for the subject process. Embodiments at step 120-5 may determine the final input dataset for method step 130. To do so, the method at 120-5 may use one or more following criteria: (i) physically significant, (ii) more predictable, (iii) less cross-correlated; and (iv) reduced or minimum in dimensions.

Model Development (130)

With reference to FIG. 2E, the method 100, at step 130, then builds a PSE model as defined in step 110 for the subject process. To build the PSE model, the method 100 at step 130 can build a simplified first-principle model, a surrogate model, a hybrid model, or build a ML model (e.g., a PCA or PLS model, a deep-learning neural network (DLNN) model) for the defined PSE problem to solve. For example, the embodiments may use the cleansed and reduced set of process variables (prepared dataset from step 120) as inputs to build a Hybrid FPM for a real-time optimization application. The method at step 130-1 may first build a base model (aka “Backbone” model), which can be a simplified first-principle model, a surrogate model based on only certain first-principle knowledge, a dimension-reduced linear PLS model and such. At step 130-2, the embodiments can enrich the base-model by embedding some AI/ML techniques, such as clustering and classification algorithms, PCA or PLS analysis, deep-learning neural network (DLNN), as well as hybrid first-principle and data-driven model (see e.g., U.S. Pat. No. 10,031,510). The enhanced modeling depends on the availability of the amount of data and the extractable and useful information contained in the data, also depends on the specific PSE problem to solve. The method at step 130-3 integrates the based model, data-driven models, and embedded AI/ML algorithms for the defined PSE problem in step 110. The method at step 130-4 can perform model validation and PSE solution evaluation through simulation, data testing, case study, and Monte Carlo experiment, etc. At the end, a validated model and PSE solution are deployed in step 130-4 for real-time application in the subject industrial plant.

Deploy Model Online (140)

With reference to FIG. 2F, the method, at step 140, deploys the model developed in step 130, for online prediction and optimization of the subject plant process. The method, at step 140-1, receives real-time input measurements from plant sensors, online analyzer readings, and lab sample analysis results, and the like, may also apply transformations or engineering equations to derive feature variables' values from the real-time measurements, and, together, are fed into the process model deployed online.

From the real-time measurements and derived feature variables' values, the process model may generate current estimates of important product properties, in a format of continuous key performance indicators (KPIs) used as indicators of the process operation over time. The generated KPIs from model prediction can be very important and helpful for a plant user (e.g., process engineer/operator) or plant system to monitor and maintain the operations of the subject plant process at a safe and optimal operation condition. For example, the plant user or system may use the KPIs to indicate current status in the subject plant process, such as process throughput, energy consumptions, product quality, profit margins, and such. The generated KPIs may be further used to support plant production planning and scheduling on the operations of the subject process.

Further, the method, at step 140-2, may deploy one or more models and execute one or more optimization tasks. These models may compare the current real-time data of the subject plant process to pre-defined performance criterions from historical data of the subject plant process. Based on the comparison, one or more models detect whether degradation in performance conditions appeared in the subject plant process.

In practice, multiple models can be developed and deployed in a same computer server (or cloud computing environment) and run simultaneously, which allow a process operator and engineer to operate and monitor their plant remotely in an operation center with more transparency and detailed process insights. Embodiments assist a process operator and engineer to develop and deploy multiple predictive models in an easy workflow and to support asset optimization, and for a long-term sustained safe operation and production, which supports manufacturers continually optimizing the performance of their assets—improving safety, managing risk, reducing downtime, enhancing productivity, and increasing profitability.

Example Applications of Building Process Model with Embedded AI

Many PSE applications can be developed and deployed by using the new paradigm and methods disclosed above, two representative examples are presented in the following sections as illustration—one is developing a hybrid model with first principles and AI/ML techniques to address those difficulties in predicting product properties with prior arts in a typical Engineering (ENG) application, the other example includes developing and deploying a plant planning and scheduling (PSC) model with embedded AI to automate operating plan validation.

In the prior approaches, PSE application practitioners often experience many pain points in developing and deploying a full-scale first-principles model for an industrial batch process. These include but not limited to (1) Creating a model for unit/plant operations is time-consuming, manual, and requires expertise, which limited the number of models used in plant operations; (2) Available data from plant is often incomplete, error-prone, and does not cover the full operating range and scenarios to build a model, that resulted in reduced model accuracy; (3) First principle models can often not capture all of the phenomena seen in operations, as a result, inaccurate model leads to sub-optimal operations; (4) Models can quickly fall out-of-sync with the plant, due to drifting conditions and the model-based optimal operation became unsustainable.

Hybrid Models with AI for Batch Process

FIGS. 3A-3I illustrate an application of methods from data loading to building and testing a hybrid model for a batch process with first-principles and AI. The process under consideration is a batch operation of special chemicals producing polyacrylate. For such a process, neither a first-principles model nor a purely data-driven statistical model alone is accurate enough to serve process operation optimization. The product quality will be known until the end of a batch operation and many operation conditions as well as uncertainties in the process will affect the product quality.

A hybrid first-principles and PLS (AI) model may facilitate the batch modeling. A fundamental, but uncalibrated first-principles model can be used to simulate the batch process and compute trajectories of some fundamental properties using whatever the data of Batch Initial Conditions (Z) and measured trajectories (X) from process operation history as inputs to the model. The computed trajectories then be merged into the batch measurements X to supplement to the batch data array with information that is missing or unreadily available from the historical process measurements only.

FIG. 3A illustrates the batch process of polymerization of polyacrylates. FIG. 3B illustrates an example of a few process variables of the batch dataset containing missing values and bad measurements. The raw dataset may be cleansed of such missing values and bad measurements (step 120-2 of method 100) to generate a cleansed dataset. The dataset is also enriched with one or more feature variables and corresponding values derived from the operation measurements of the dataset (step 120-3 of method 100).

FIG. 3C illustrates an example of the hybrid modeling data merging and the techniques of how to combine first-principles (domain-knowledge) through simulation data with plant historical operational data. The plant batch operation measurements can be viewed as a 3-dimension data array, a schematic illustration of a typical batch process historical batch dataset recorded from past batch runs and organized in a 3-way structure is marked “Plant Data X” as shown in FIG. 3C. Along the horizontal are variable measurements, vertical are data from different batches, and along the time (3^{rd} dimension), are time series trajectories for each variable.

A similar 3-dimentional dataset X′ is created using a first-principle model simulation. It consists of one or more unmeasurable batch properties marked as Simulation Data X′ as computed variables that contains useful information about the batch operation from the first-principles (e.g., physical and chemical relations among the measurable and unmeasurable batch variables, batch mass-balance, energy-balance, and operational constraints).

Dataset X and X′ are then combined as merged dataset [X X′] as inputs and the batch product quality measurement Y as outputs being used to build or train a hybrid model for the underlining batch process. The hybrid model can be a linear PLS model or a nonlinear DLNN model dependent on the application. It should be noted that the computed variable trajectories by an uncalibrated first-principle model will be quite biased, but since the PLS model only looks at deviations from their mean trajectories, it is only important that these deviations are informative. Therefore, the model calibration work for a typical first-principle model can be simplified or completely skipped for building such a hybrid model.

FIG. 3D illustrates an example of the hybrid modeling work-flow, which explains some of the implementation detailed steps of the example embodiment. FIG. 3E illustrates example results of the hybrid modeling with significantly improved accuracy in model predictions. More details of this illustrative application example can be found at U.S. Application No. 62/845,686, filed on May 9, 2019, which is incorporated herein by reference in its entirety.

Automatic Operating Plan Validation with AI for Planning and Scheduling (PSC)

The other illustrative application example is dealing with an automatic monthly operation plan (MOP) validation problem. Operational planning in process industries involves the creation of operating plans that contain guidelines for operating the organization's facilities. In oil refineries, for example, the plan is issued monthly (MOP). These plans dictate the profitability of the organization's operation, so they need to be thoroughly reviewed before they are issued.

In prior approaches, planners use heuristics and their expertise to compile collected data from multiple sources (e.g., supply demand, plant inventory, capacity, turnaround schedule), enter information into a planning and scheduling system (e.g., AspenTech PIMS™), and create many cases that capture what-if scenarios. Then several resources from across the organization validate the MOP plans and only one plan is accepted to implement in the plant production. In this MOP plan creation and execution process, there are several pain points in practice: (1) The application requires a very experienced planner and creation of dozens of cases to analyze; (2) MOP plan validation needs collective expertise and multiple iterations, that can be very time-consuming; (3) Once a final MOP is accepted, it cannot be changed and must be implemented in the plant; the quality of the MOP is, therefore, critical for plant profitable operation.

An expert assistant with AI on MOP validation can be very helpful—not only to reduce the work on experienced planner, but also to accelerate the learning curve for junior planners.

FIG. 3F illustrates an example of workflow for building a MOP case model using AI technique from historical data. A model may have many process parameters (e.g., a number of process variables or process constraints) that represent the status of an industrial process. In some scenarios, the model contains numerous (e.g., over 10,000) such parameters.

An instance of a model is known as a “case.” A case may include many parameters. As such, a user can create multiple cases of the model, and in each case the corresponding parameters may have different values, in order to represent different scenarios, such as different seasons (spring, summer, fall, and winter). Following the example new paradigm shown in FIG. 1A, the PSE application is defined as a MOP cases clustering and classification problem, and the solution is building such a model able to classify historical MOP cases and identify important inputs/features to have impacts on case output.

As illustrated in FIG. 3F, the MOP model building starts with selecting data sources and loading historical MOP cases data, then the data is cleaned and preprocessed with steps as described in method 120. A Principal Component Analysis (PCA) model is first fit with the cleaned dataset, all features are feed into a PCA model and only those relatively important contributor features (based on statistics and domain knowledge) are selected in feature engineering step. Then only those selected key features are fed as base to build a second PCA model. This feature-reduced PCA model automatically clusters the cases in a latent-variable plan (e.g., T₁-T₂ plots). Alternatively, a user may also apply other AI techniques such as Hierarchical Clustering or DB Scan to build the MOP case model. More details about MOP cases data clustering can be found at U.S. application Ser. No. 16/372,970, filed Apr. 2, 2019, which is incorporated herein by reference in its entirety.

FIG. 3G illustrates an example of a workflow for a MOP case model deployed to validate a new MOP case. This is applicable to a number of candidate MOP cases generated from a Planning System (such as Aspen Tech PIMS™) for different scenarios. The user may select one or more cases and load both PCA model (reduced-features) and new MOP case data. The example embodiment then maps the new case data onto the PCA latent-variable space (e.g., a dimension-reduction technique in AI) and using the same scaling and centering. In a reduced PCA latent-variable space, the original high-dimension data can be easily viewed and compared in a 2-dimension plan (i.e., T₁˜T₂, T₁˜T₃, or Tᵢ˜Tⱼ; where T₁, T₂, T₃, . . . Tᵢ are called the first, second, and the ith principal components, or PCs, which may represent major portion of the variance and their locations in the PC plan form many clusters, and the data distributions in each cluster represent if they share similar features in a multivariate sense).

FIG. 3H illustrates an example of a deployed PCA model that is created with 52 key features selected from 5000 raw variables. The PCA model clearly identifies four significant clusters of MOP cases in a T₁˜T₂ plot, as marked as “Summer,” “Winter,” “Lubes,” and “HDS Turnaround” in FIG. 3H. A new case can be represented as a new data point in the Tᵢ˜Tⱼ plot after its 52 key features values are mapped onto the PCA model. FIG. 3I shows an example of an irregular case where its features mapping onto the T₅˜T₆ plan appeared way off from any of the regular case clusters. In fact, this validation identifies the irregular case correctly in an early stage and avoid big economic loss from execution of the MOP plan.

Network Environment for Building and Deploying Process Models

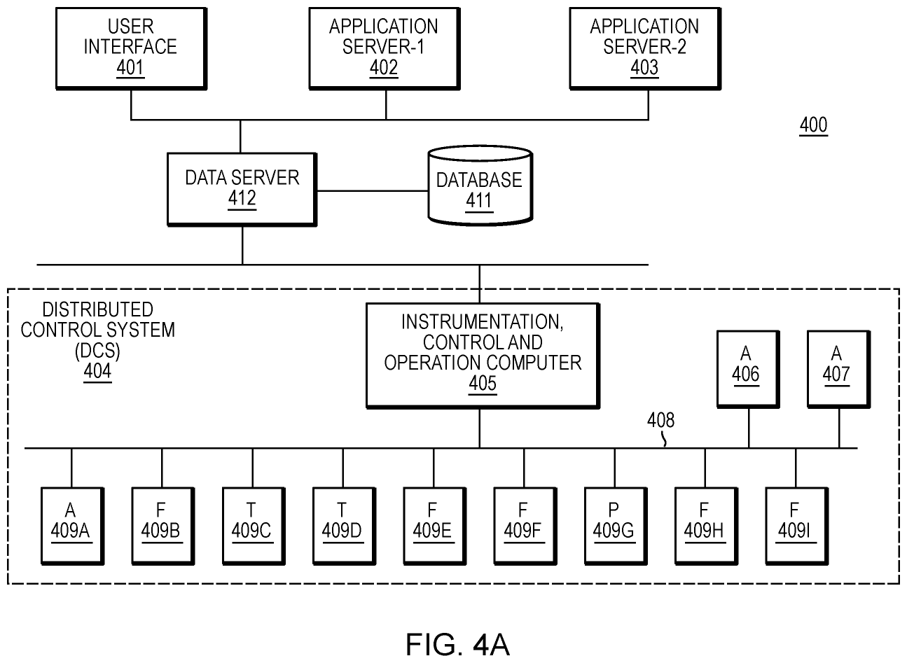

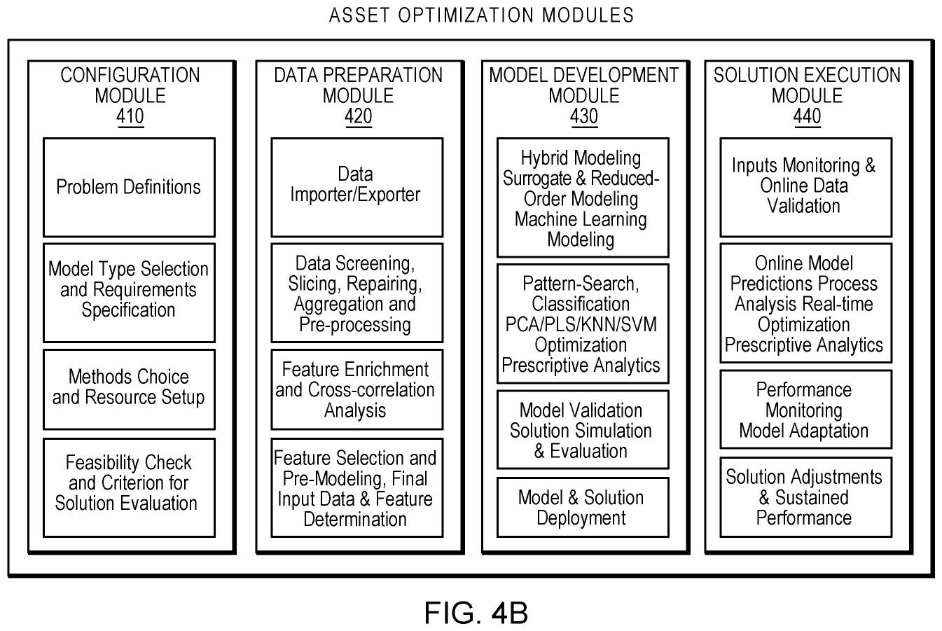

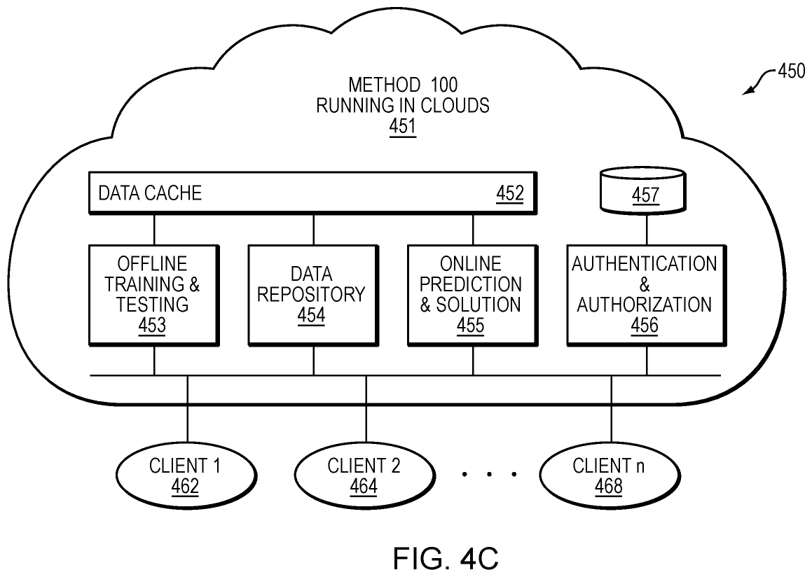

FIG. 4A is a block diagram illustrating an example network environment 400 for building and deploying process models in embodiments of the present invention. The system 400 may be configured as part of the computer network that supports the process operations of a chemical or industrial plant, or refinery, which includes a formidable number of measurable process variables, such as temperature, pressure, and flow rate variables. In some embodiments, the network environment 400 executes the methods of FIGS. 2A-2F to build and deploy PSE models to monitor and optimize real-time plant operations. FIG. 4B illustrates various functional computer modules that can be used by the network environment in FIG. 4A to build and deploy PSE models and execute PSE solutions.

The system 400 of FIG. 4A includes a first application server (Application Server-1) and a second application server (Application Server-2) 403, which may operate as a predictor and optimizer. In some embodiments, each of the application servers 402, 403 may operate in real-time as the predictor and optimizer of the present invention alone, or the application servers 402, 403 may operate together as distributed processors contributing to real-time operations as a single predictor and optimizer. In other embodiments, additional system computers (application servers) may also operate as distributed processors contributing to the real-time operation as a predictor and optimizer.

The application servers 402, 403 may communicate with the data server 412 to access collected data for measurable process variables from a historian database 411. The data server 403 may be further communicatively coupled to a distributed control system (DCS) 404, or any other plant or refinery control system, which may be configured with instruments 409A-409I, that collect data at a regular sampling period (e.g., one sample per minute), and 406, 407 that collect data at an intermittent sampling such as online analyzers (e.g., 20-30 minutes per sample) for the measurable process variables. The instruments may communicate the collected data to an instrumentation computer 405, also configured in the DCS 404, and the instrumentation computer 405 may in turn communicate the collected data to the data server 412 over communications network 408. The data server 412 may then archive the collected data in the historian database 411 for process PSE modeling and optimization purposes. The data collected varies according to the type of subject (or target) plant process.

The collected data may include measurements for various measurable process variables. These measurements may include a feed stream flow rate as measured by a flow meter 409B, a feed stream temperature as measured by a temperature sensor 409C, component feed concentrations as determined by an analyzer 409A, and reflux stream temperature in a pipe as measured by a temperature sensor 409D. The collected data may also include measurements for process output stream variables, such as the concentration of produced materials, as measured by analyzers/instruments 406 and 407. The collected data may further include measurements for manipulated input variables, such as reflux flow rate as set by valve 409F and determined by flow meter 409H, a re-boiler steam flow rate as set by valve 409E and measured by flow meter 409I, and pressure in a column as controlled by a valve 409G. The collected data reflect the operating conditions of the representative plant during a particular sampling period. The collected data is archived in the historian database 411 for process modeling and optimization purposes. The data collected varies according to the type of target process.

In FIG. 4A, Application Server-1 402 may be configured to include an input data preparation module 420 of FIG. 4B. Application Server-1 402 is communicatively coupled to a user interface 401. From the user interface 401, a user (e.g., plant engineer, plant operator, or other plant personnel) may initiate building of a PSE model. To do so, the user, via the user interface 401, may select candidate process variables for building the PSE model. For example, the user, through user interface 401, may interact with a plant piping and instrumentation diagram/drawing (P&ID), as shown in FIG. 3A.

In response, the user interface 401 may communicate with the data importer/exporter of the input data preparation module 420 (configured on Application Server-1 402), which loads the historical plant measurements for the selected candidate variables, via the data server 412, from a database 411 (e.g., plant historian or asset database). The historical measurements may include data currently or previously collected from sensors, including 406 and 407, by the Instrumentation, Control, and Operation Computer 405 of the DCS 404. The data importer/exporter generates a dataset from the loaded historical measurements of the selected process variable candidates (which may be stored by the data importer/exporter in database 411).

From the user interface 401, the user may then initiate and complete steps of 100 as shown in FIGS. 2C-2F. That is, the steps may screen and cleanse certain preselected process variables, from which measurements may be used to build and train the PSE models. For example, the user, via user interface 401, may request data cleansing to be performed on the generated dataset (or a plant system of network environment 400 may automatically request the performance of data cleansing). In response, the user interface 401 may communicate with the input data preparation module 420 (of Application Server-1 402) to perform functions on the dataset that may include data screening, slicing, repairing, and pre-processing to reduce the dataset (e.g., remove bad quality data segments and measurements for uninformative process variables). In some embodiments, the input data preparation module 420 may execute step 120-3 of method 100 to perform input feature enrichment on the dataset.

The user, via user interface 401, may also request input feature enrichment and dynamic cross-correlation analysis be performed on the generated dataset (or a plant system of network environment 400 may automatically request the input feature enrichment and cross-correlation analysis). In response, the user interface 401 may communicate with the input data preparation module 420 (of Application Server-1 402) to perform functions using step 120-3 of method 100 to generate various feature enriched variables' values as inputs added to the dataset stored in database 411. The preparation module 420 then dynamically analyzes the correlation of the enriched variables' values and measured process variables' values using step 120-4 of method 100. The input data preparation module 420 may further identify highly correlated input variable groups based on the cross-correlation analysis as described in step 120-4. The input data preparation module 420 may further reduce the enriched dataset by removing identified redundant inputs in each highly correlated input group, and eliminating less-contributed inputs through feature selections as described in step 120-4 to generate a sub-dataset.

The user, via user interface 401, may also request feature selection and statistical modeling (PLS modeling) be performed on the enriched dataset (or a plant system of network environment 400 may automatically request the feature selection and PLS modeling). In response, the user interface 401 may communicate with the input data preparation module 420 (of Application Server-1 402) to perform functions to select final input variables for the PSE model through a feature selection processes (step 120-4 of method 100). The module 420 (of Application Server-1 402) may further build and execute a PLS model. In some embodiments, the built/executed model may project the remaining measurements/derived values of variables of the sub-dataset into a lower dimension latent structure space. The input data preparation module 420 may further reduce the dataset to include only those measurements/derived values determined to most contribute to the process outputs. The input data preparation module 420 may also truncate the determined latent variables for use in building/training the PSE models. The reduced dataset and determined latent variables may be stored in the database 411.

In FIG. 4A, Application Server-2 403 may be configured as a model training module 430 and model execution module 440. The Application Server-2 403 is communicatively coupled to Application Server-1 402 and the user interface 401. From the user interface 401, a user (e.g., plant engineer, plant operator or other plant personnel) may initiate building and validating PSE models. In response, the user interface 401 may communicate with the model training module 430, to build the PSE models. The model training module 430, using the reduced dataset or determined latent variables, performs functions for training the PSE models for process online optimization. The model training module 430 then validates the built/trained PSE models and deploys the models online.

Using the deployed PSE models, the model execution module 440 may perform process optimization online for a plant process. The model execution module 440 may use the PLS model in parallel with the deployed PSE models, to perform input monitoring using statistics (e.g., T2, SPE, and such) generated from the PLS model.

The model execution module 440 may also automatically provide input (adjust parameters/variables/constraints) to the DCS 404, or any other plant or refinery control system or processing system coupled to the DCS system 404. The Instrumentation, Control, Operation Computer 405, based on the input, may then automatically adjust or program (via network 408) physical valves, actuators, heaters, and the like 409A-409I, or program any other plant or refinery control system or processing system coupled to the DCS system 404, to execute the calculated PSE solution in the plant process. The model execution module 440 may also provide operation status and optimization results to the user interface 401 for presentation to the user, and the user, via the user interface 401, may initiate actions (e.g., adjust or program physical equipment) at the DCS system 404 or other plant or refinery control system or processing system coupled to the DCS system 404. In this way, embodiments support manufacturers continually optimizing the performance of their assets—improving safety, managing risk, reducing downtime, enhancing productivity, and increasing profitability.

FIG. 4C illustrates a block diagram depicting an example cloud computing environment 450 for building and deploying PSE models in embodiments of the present invention. Such an environment 450 is capable of handling a large number of applications and, in super-fast-speed, performing multiple tasks related to modeling, predicting, and optimizing process operations. The environment 450 of FIG. 4C can perform the method 100 steps described in FIGS. 2A-2F. The cloud computing environment 450 includes a cloud computing engine 451 configured to perform offline model training and testing 453, online model predicting and optimizing 455, and authentication and authorization 456. The cloud computing engine 451 is also coupled to a data repository 454, data cache 452, and authentication & authorization database 457. The cloud computing engine 451 receives requests from any one of the shown clients 462, 464, . . . , 468. The cloud computing engine 451 checks the received requests by completing authentication and authorization 456 on the received request. The cloud computing engine 451 only executes tasks that are permitted according to the authentication and authorization 456 (i.e., what to do, what can do, and how to do it). Using authenticated/authorized requests, the powerful cloud computing engine 451, in a super-fast way, builds, trains, and tests 453 PSE models and deploys these models online to predict and optimize 455 a plant for a subject process. The cloud computing engine 451 then sends back results and reports to clients 462, 464, . . . , 468.

Digital Processing Environment

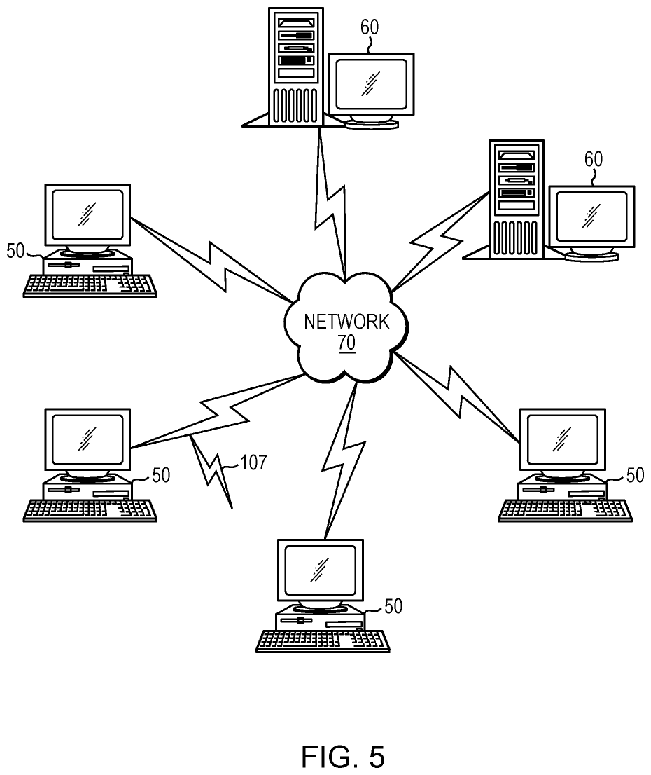

FIG. 5 illustrates a computer network or similar digital processing environment in which the present invention may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

For example, server computers 60 may also be configured as Data Server 412 for loading historical plant data (e.g., measurements and enriched feature values) from Database 411 into a dataset in the network architecture 400 (e.g., by executing step 120-1 of method 100). Server computers 60 may also be configured as Application Server-1 402 (including an input data preparation module 420) to reduce process variables' measurements and enriched feature variables' values from the dataset (e.g., by executing steps 120-2 to 120-5 of method 100). Server computers 60 may further be configured as Application Server-2 403 (including model training module 430 and model execution module 440) to build and deploy a PSE model (e.g., by executing steps 130-1 to 130-4 of method 100). The server computers 60 may also be configured as an Instrumentation, Control, and Operation Computer 405 that is configured as part of the DCS 404 in the network architecture 400. The Instrumentation, Control, and Operation Computer 405 may be communicatively coupled to client devices 50, including sensors 406-407 and other measurement control devices (valves, actuators, heaters, and the like 409A-I) for adjusting a plant process based on the built and deployed PSE model and optimization solution.

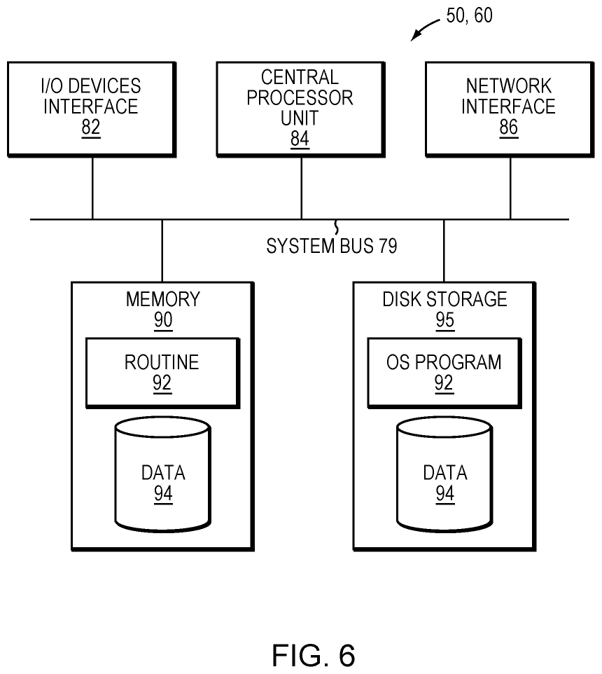

FIG. 6 is a diagram of the internal structure of a computer (e.g., client processor/device 50 or server computers 60) in the computer system of FIG. 5. Each computer 50, 60 contains system bus 79, where a bus is a set of hardware lines used for data transfer among the components of a computer or processing system. Bus 79 is essentially a shared conduit that connects different elements of a computer system (processor, disk storage, memory, input/output ports, network ports, etc.) that enables the transfer of information between the elements. Attached to system bus 79 is I/O device interface 82 (such as user interface 401 of the network architecture 400 of FIG. 4A) for connecting various input and output devices (keyboard, mouse, displays, printers, speakers, etc.) to the computer 50, 60. Network interface 86 allows the computer to connect to various other devices attached to a network (e.g., network 70 of FIG. 5). Memory 90 provides volatile storage for computer software instructions 92 and data 94 used to implement an embodiment of the present invention (e.g., PSE model built and deployed in the processes of FIGS. 2A-2F). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, the program product 92 may be implemented as a so-called Software as a Service (SaaS), or other installation or communication supporting end-users.

Advantages of the Disclosed Systems and Methods

Process System Engineering (PSE) has constantly progressed over the last three decades, however, the current practice is still facing many challenging problems. PSE applications often have to deal with ill-defined problems, noisy data, model uncertainties, nonlinearities, and a need for speedy solutions. AI and ML, shows promise to solve complex problems in similar conditions with pattern recognition, high dimension reasoning, and decision-making. In the process industry, successful applications are also reported to offer predictive and prescriptive maintenance of equipment failures in locomotives of CSX; details are disclosed in U.S. Pat. Nos. 9,535,808 and 10,114,367 (which are incorporated herein by reference in their entirety). In an effort to expand the AI/ML, technology applications in process industry, such as refinery, chemical, or petrochemical plants, the prior arts in current practices showing some limitations and following difficulties need to be addressed.

(1) Model Complexity and High Costs to Maintain Sustained Performance

First principles models have been widely used offline in petroleum, chemical, and process industries for process design, simulation, debottlenecking analysis and optimization over the last 30 years because of their accuracy and transparency in fundamental physical and chemical principles. Commercial engineering software for offline applications using first principles models have also advanced tremendously over the last 30 years (such as ASPEN Plus™ and HYSYS™), and during this time, efforts have also been made to use first principles models online for real-time applications, such as online process optimization and control. First principles models have many well-known advantages over pure data-driven black-box models that are typically used online. These advantages include being more rigorous and reliable for simulating and predicting process behavior, providing broader coverage of complex nonlinearities, and providing better extrapolations. However, a full-scale first principle model is very complex (e.g., it may contain thousands of variables and equations) and is difficult to calibrate and sustain performance when plant production plan/schedule changes, while today's production of process industrial products often require more flexibility and scalability due to the rapid changes in material prices and market demands. In fact, much important information can be extracted and utilized from previous human-made decisions over history and various available historical market and plant data and, here, AI and ML techniques can be embedded into an application and help to reduce the complexity of a model, speed-up decision-making for an optimal solution, and therefore address many difficulties in the prior arts, e.g., use of a simple surrogate first-principles model or a hybrid model online for speedy real-time prediction and optimization. The disclosed systems and methods provide such systematic approaches to combine the merits of a first-principle based simplified model and a data-driven complementary model to satisfy today's manufactures' production and asset optimization requirements.

(2) High Dimension of Problems and Speedy Optimization Needed

In current practice, production and scheduling is another area where the decision-making process needs to compare and solve very high-dimension optimization problems in a short-time. With current best optimization solvers, given a set of different conditions and physical constraints for a plant, obtaining an optimum production plan and schedule requires very intensive computations and may still take many hours to converge to a solution. This may be too late. Here AI and ML provide an opportunity to help by first performing a dimension-reduction based on data-driven techniques (e.g., clustering and classification with PCA, SVM, or other ML algorithms) and early dropping of many duplicated or redundant cases to assess, therefore speed up the optimization (decision-making process) significantly. The disclosed embodiments provide systematic methods to address the high-dimension problem reduction issue with embedded ML techniques.

(3) Either Modeling Approach has Weakness and Limitations

As described in (1), a rigorous first-principle model is ideal, in theory, for a PSE application. In practice, however, for an online application, its complexity and uncertainty with too many parameters have heavily limited its applications in the process industry due to their limited feasibility and sustainability. The emerging AI and ML models show promise in the process industry, but ML model training requires a very large amount of data that is usually not available from plant operations. Using an offline calibrated or uncalibrated rigorous first-principle model to generate simulation data to complement the dataset required for training a ML model is a solution. The disclosed embodiments provide approaches and example applications on how to use first-principle model to support ML model training through simulations.

(4) Model and Solution Can't Self-Sustain

Another challenge to process engineers in PSE practices is that a well-developed and calibrated model or solution is difficult to self-sustain. Once the operation conditions vary, the deployed model and solution may be no longer valid for an optimal prediction or solution. The disclosed embodiments also provide systematic methods to address this issue by: (a) defining a qualitative measure of the performance of a model or solution; (b) a criterion to trigger a self-adaptation procedure; (c) a diagnostic algorithm to identify the root-cause of performance degradation; (d) a self-model adaption mechanism; and (e) self-monitoring on data and performance of the application.

The teachings of all patents, published applications and references cited herein are incorporated by reference in their entirety.

It should be understood that in other embodiments the present invention may be used in a wide variety of other types of equipment, or technological processes in the useful arts.

While example embodiments have been particularly shown and described, it will be understood by those skilled in the art that various changes in form and details may be made therein without departing from the scope of the embodiments encompassed by the appended claims.

What is claimed is:

1. A method of building and deploying a model to optimize assets in an industrial process, the method comprising:
generating a dataset by loading a set of process variables of a subject industrial process, each process variable including measurements related to at least one component of the subject industrial process;
identifying and removing measurements that are invalid in quality for modeling a failure in the subject industrial process;
enriching the dataset by deriving one or more feature variables and corresponding values based on the measurements of the set of process variables, and adding to the dataset the values corresponding to the one or more derived feature variables;
identifying groups of highly correlated inputs by performing cross-correlation analysis on the dataset;
selecting features of the dataset using (a) a representative input from each identified group of highly correlated inputs, and (b) measurements of process variables not in the identified groups of highly correlated inputs;
building and training a process model based on the selected features of the dataset; and
deploying the process model to optimize assets for real-time operations of the subject industrial process.

2. The method of claim 1 further comprising defining a process system engineering (PSE) problem of asset optimization with mathematical equations, first principles and domain knowledges, model structures, and physical and economical constraints.

3. The method of claim 2 wherein defining a PSE problem for asset optimization includes at least one of:
using first principles and process domain knowledges to describe an asset optimization as a set of mathematical equations, and maximizing or minimizing one or more objective functions and subject to certain constraints;
selecting model structures and including at least one of the simplified first-principle models, surrogate models, hybrid models, PCA or PLS models, machine-learning (ML) models; and
incorporating physical or economical constraints;

4. The method of claim 1 wherein the measurements of each process variable are loaded in a time-series format or structured data format from at least one of a plant historian data, plant asset database, plant management system, formatted spreadsheet, formatted text file, and formatted binary file.

5. The method of claim 1 wherein the measurements that are invalid in quality include at least one of: missing values, frozen signals, outlier values, values out of process in high and low limits, and extremely high noisy values.

6. The method of claim 1 further comprising repairing the invalid in quality measurements by at least one of: filing in missing values using interpolation, applying none-phase-shift filters to de-trend drifting and filter noisy values, replacing values with model-produced values, up-sampling values with snapshots or calculated averages, and down-sampling values with interpolated values.

7. The method of claim 1 wherein deriving the one or more feature variables and corresponding values includes using at least one of: an engineering equation, engineering domain knowledge, plant economics equations, plant economics domain knowledge, planning and scheduling knowledge, primal and dual information resulting from an economic optimization of the underlying plant asset, a nonlinear transform, a logarithm transform, quadratic or polynomial transform, a statistical measurement over time for a time-series dataset, a calculation of a moving average value, estimates of rate of change, a calculation of standard deviation over time, a calculation of moving standard deviation, and a calculation of moving changing rate.

8. The method of claim 7 wherein deriving the one or more feature variables and corresponding values includes using engineering domain knowledge, and wherein engineering domain knowledge includes at least one of: computation of a compression efficiency of a compressor, computation of a flooding factor of a distillation column, computation of internal refluxes flow, and a user defined key performance indicator for the subject industrial process.

9. The method of claim 7 wherein deriving the one or more feature variables and corresponding values includes using plant economics domain knowledge, and wherein plant economics domain knowledge includes at least one of: optimization of an underlying asset model, computation of a corresponding objective function, and the computation of all primal and dual values resulting from the solution of the underlying optimization problem.

10. The method of claim 1 wherein the process model is built using a simplified first principles model, a hybrid model, a surrogate model, or a regression model.

11. The method of claim 1 wherein the process model is trained as a clustering model, classification model, a dimension-reduction model, or a deep-learning neural network model.

12. The method of claim 1 wherein deploying the process model includes executing the process model to monitor, predict, or perform one or more asset optimization tasks for the real-time operations of the subject industrial process.

13. The method of claim 1 wherein deploying the process model and performing online PSE optimization includes self-monitoring and detection on model and PSE solution performance degradation by using one or more quantitative or statistical measurement index.

14. The method of claim 1 wherein deploying the process model and performing online PSE optimization further includes auto-calibrating and auto-validating functionality and starting a model adaptation process by using available recent performance data of the system and process measurements.

15. A computer system for building and deploying a model to optimize assets in an industrial process, the system comprising:
a processor operatively coupled to a data storage system, the processor configured to implement:
a data preparation module configured to:
generate a dataset by loading a set of process variables of a subject industrial process, each process variable including measurements related to at least one component of the subject industrial process;
identify and remove measurements that are invalid in quality for modeling a failure in the subject industrial process;
enrich the dataset by deriving one or more feature variables and corresponding values based on the measurements of the set of process variables, and adding to the dataset the values corresponding to the one or more derived feature variables;
identify groups of highly correlated inputs by performing cross-correlation analysis on the dataset; and
select features of the dataset using (a) a representative input from each identified group of highly correlated inputs, and (b) measurements of process variables not in the identified groups of highly correlated inputs;
a model development module configured to build and train a process model based on the selected features of the dataset; and
an execution module configured to deploy the process model to optimize assets for real-time operations of the subject industrial process.

16. The system of claim 15 wherein the data preparation module is further configured to load measurements of each process variables in a time-series format or structured data format from at least one of a plant historian data, plant asset database, plant management system, formatted spreadsheet, formatted text file, and formatted binary file.

17. The system of claim 15 wherein the measurements that are invalid in quality include at least one of: missing values, frozen signals, outlier values, values out of process in high and low limits, and extremely high noisy values.

18. The system of claim 15 wherein the data preparation module is further configured to repair the invalid in quality measurements by at least one of: filing in missing values using interpolation, applying none-phase-shift filters to de-trend drifting and filter noisy values, replacing values with model produced values, up-sampling values with snapshots or calculated averages, and down-sampling values with interpolated values.

19. The system of claim 15 wherein the data preparation module is further configured to derive the one or more feature variables and corresponding values using at least one of: an engineering equation, engineering domain knowledge, a nonlinear transform, a logarithm transform, quadratic or polynomial transform, a statistical measurement over time for a time-series dataset, a calculation of a moving average value, estimates of rate of change, a calculation of standard deviation over time, a calculation of moving standard deviation, and a calculation of moving changing rate.

20. The system of claim 19 wherein the data preparation module is configured to derive the one or more feature variables and corresponding values using engineering domain knowledge, and wherein engineering domain knowledge includes at least one of: computation of a compression efficiency of a compressor, computation of a flooding factor of a distillation column, computation of internal refluxes flow, and a user defined key performance indicator for the subject industrial process.

21. The system of claim 15 wherein the model development module is configured to build the process model using a simplified first principles model, a hybrid model, a surrogate model, or a regression model.

22. The system of claim 15 wherein the model development module is configured to train the process model as a clustering model, classification model, a dimension-reduction model, or a deep-learning neural network model.

23. The system of claim 15 wherein the execution module is configured to execute the process model to monitor, predict, or perform one or more asset optimization tasks for the real-time operations of the subject industrial process.

24. The system of claim 15 further comprising a configuration module configured to automatically select a model type for the model development module to build and train the process model.

25. A non-transitory computer-readable data storage medium comprising instructions causing a computer to:
generate a dataset by loading a set of process variables of a subject industrial process, each process variable including measurements related to at least one component of the subject industrial process;
identify and remove measurements that are invalid in quality for modeling a failure in the subject industrial process;
enrich the dataset by deriving one or more feature variables and corresponding values based on the measurements of the set of process variables, and adding to the dataset the values corresponding to the one or more derived feature variables;
identify groups of highly correlated inputs by performing cross-correlation analysis on the dataset;
select features of the dataset using (a) a representative input from each identified group of highly correlated inputs, and (b) measurements of process variables not in the identified groups of highly correlated inputs;
build and train a process model based on the selected features of the dataset; and
deploy the process model to optimize assets for real-time operations of the subject industrial process.
